(19) United States
(12) Patent Application Publication
(10) Pub. No.: US 2012/0270001 A1
(43) Pub. Date: Oct. 25, 2012

(54) Label with an Active Portion

(75) Inventors: Joseph D. Franko, SR., Ham Lake, MN (US); Joseph D. Franko, JR., Robbinsdale, MN (US)

(73) Assignee: Quality Assured Enterprises Inc., Hopkins, MN (US)

(21) Appl. No.: 13/256,067

(22) PCT Filed: Jan. 11, 2011
(86) PCT No.: PCT/US11/20804

§ 371 Date: Sep. 12, 2011

Related U.S. Application Data
(60) Provisional application No. 61/294,770, filed on Jan. 13, 2010.

(51) Int. Cl. G09F 3/20; G09F 3/04; G09F 3/10; B32B 33/00; B32B 7/14; C09J 7/02

(52) U.S. Cl. 428/40.1; 428/201; 428/352; 428/354; 428/43

(57) ABSTRACT

A roll-fed label web for a label with an active portion includes a base ply, at least one top ply, a plurality of separate, repeating cut zones, and a plurality of separate, repeating bond areas between the base ply and the at least one top ply. The separate, repeating bond areas are set back from the cut zones, and alternatively define a hinge and a release-reseal system. An individual label with an active portion is produced from the roll-fed label web when the web is cut at the cut zones by a label application machine. The individual label thus produced has adhesive-free opposing ends.

### CROSS-REFERENCE TO RELATED APPLICATION

Benefit is hereby claimed of U.S. Provisional Patent Application Ser. No. 61/294,770 filed on 13 Jan. 2010.

### TECHNICAL FIELD

This disclosure relates generally to labels. More particularly, this disclosure relates to a label with an active portion that may be used with existing roll-fed labeling equipment for application to containers and other objects.

### BACKGROUND

In the printing arts, and in particular in the printed label art for labeling and decorating objects, there exists a continual demand for labels and decorations which not only appeal to consumers, but also bear ever increasing amounts of information. For example, labels for identification of health care and pharmaceutical products are often required by governmental regulations to describe in painstaking detail their compositions and ingredients. As new food and drug laws are passed, regulations require the inclusion of increasing amounts of label information. As another example, labels for identification of agricultural and industrial products are similarly required by governmental regulations to describe their compositions and ingredients by way of, e.g., “material safety data sheets” and the like.

One label that has gained wide popularity is a so-called “roll-fed” label. A roll-fed label commonly utilizes a continuous label substrate or base ply comprising paper, or a clear or opaque film such as polypropylene, or a combination of paper and film. In such an individual label, in its final state, the base ply is usually rectangular, as defined by a desired label width associated with a widthwise dimension and a desired label length associated with a lengthwise dimension (transverse to the widthwise dimension). The base ply has opposing first and second ends, along with front and back surfaces. Desired graphics are typically printed on the front surface of the base ply, and may also be printed on the back surface. In application of the roll-fed label to an object to be labeled, e.g., a cylindrical container, a widthwise portion of the back surface of the base ply at the first end thereof is adhered to the container by means of an adhesive material at point of application from labeling equipment. The base ply, having been adhesively secured to the container at the first end, is then placed in circular fashion around the container and adhesively secured at the second end of the base ply adjacent to the first end. The length of the base ply is usually chosen to approximate a circumference of the container, to minimize excessive overlap of the opposing ends of the label substrate applied to the container. The application of the label to the container may be carried out by any suitable roll-fed label applicator such as those available from, e.g., Krones A. G. of Regensburg, Germany, and B&H Labeling Systems of Ceres, Calif., U.S.A.

Roll-fed labels of the type described herein are manufactured for application by customers using conventional roll-fed labeling equipment or machines. They are produced without any adhesive material on the back surface of the base ply; and as such they are provided to customers in roll form as a web.

Typically, at point of application, a web of labels in roll form is introduced to a customer's label application machine which cuts the web into individual labels and applies them to objects to be labeled (e.g., containers). Any adhesive material used to apply the labels to the objects is supplied by the label application machine at the point of application and is generally applied to adhere the leading and trailing edge portions of the labels.

In general in the labeling and packaging arts, various forms of so-called “extended text” or “expanded content” labels have provided increasing amounts of printed information as may be desired for a particular labeling task. One such extended text label type that has gained wide popularity is the booklet type label, where a base ply is joined to a top ply via an adhesive coupling or “hinge” between the two plies.

Traditional extended text, expanded content, or booklet type labels (collectively, “booklet type labels”), however, are usually not capable of being successfully utilized with typical roll-fed label application equipment. The traditional booklet type labels may require extensive and complex tooling changes to roll-fed label application equipment or machines for accommodation of longer, overlapping ply lengths that may be required in such traditional booklet type labels, disadvantageously resulting in longer “repeats” as known in the art. Additionally, such traditional labels often require multiple adhesive and release coating depositions, resulting in longer label fabrication and application times.

In particular, a traditional booklet type label has a base ply having width dimensions nearly identical to that of any other plies above it or top plies. The width dimension is generally the dimension perpendicular to the length of the label web. When applied to a generally cylindrical container such as a conventional aerosol spray can, subsequently with a cap, the cap likely will interfere with the label plies comprising the booklet. This is due to the configuration of such containers, having necked-in or shoulder portions (i.e., upper or lower extremities of increasing or decreasing circumference) to which the cap abuts and to which the labels need to at least partially conform. In a single-ply label that does not provide a booklet function, an abutting cap simply abuts or covers a topmost portion of the label as well. But in contrast, in the case of a booklet type label, the cap may need to be removed before the plies—or booklet pages—can be accessed due to the abutting and thus interfering cap.

Therefore, there exists a need for a label with an active portion that does not require modification of existing roll-fed label application equipment or machines, and does not require significant changes to label ply materials, adhesive materials at point of application, or other labeling components. There also exists a need for a label with an active portion that satisfactorily functions as a booklet type label when applied to a container such as a conventional aerosol spray can, subsequently with a cap, even when the cap abuts or covers a portion of the label.

### SUMMARY

This disclosure describes novel labels that do not require modification of existing roll-fed label application equipment or machines for application of the labels to objects to be labeled.

In one aspect, a roll-fed label web for a label with an active portion includes a base ply, at least one top ply, a plurality of separate, repeating cut zones, and a plurality of separate, repeating bond areas between the base ply and the at least one top ply. The separate, repeating bond areas are set back from the cut zones, and alternatively define a hinge and a release-reseal system. An individual label with an active portion is produced from the roll-fed label web when the web is cut at the cut zones by a label application machine. The individual label thus produced has adhesive-free opposing ends.

In another aspect, a roll-fed label web for a label with an active portion includes a base ply, at least one top ply, a plurality of separate, repeating cut zones, and a continuous bond area between the base ply and the at least one top ply. The continuous bond area is defined by flood coats of an adhesive material and a release material. An individual label with an active portion is produced when the roll-fed label web is cut at the cut zones by a label application machine, and a hinge portion is effectively produced when the label is adhered to an object at point of application.

In another aspect, a roll-fed label web for a label with an active portion includes a base ply, at least one top ply, a plurality of separate, repeating cut zones, and at least one bond area between the base ply and the at least one top ply. The at least one bond area is defined by adhesive materials selected from a group consisting of a flood coat of adhesive material in at least one selected area, and a continuous flood coat of adhesive material. An individual label with an active portion is produced when the roll-fed label web is cut at the cut zones by a label application machine. The adhesive material of the label is relatively less aggressive as compared to other adhesive materials, and at least one of the base ply and the at least one top ply inherently has a release property.

In another aspect, a roll-fed label web for a label with an active portion includes a base ply, at least one top ply, and a plurality of separate, repeating cut zones. An individual label with an active portion is produced when the roll-fed label web is cut at the cut zones by a label application machine. At least one of the base ply and the at least one top ply is a cling-like material.

In another aspect, a roll-fed label web for a label with an active portion includes a base ply, at least one top ply, a plurality of separate, repeating cut zones, at least one bond area between the base ply and the at least one top ply, and a release material on a back surface of the base ply. The at least one bond area is defined by an adhesive material and a release material. An individual label with an active portion is produced when the roll-fed label web is cut at the cut zones by a label application machine, and a hinge portion is effectively produced when the label is adhered to an object at point of application.

In another aspect, a roll-fed label web for a label with an active portion includes a base ply, at least one top ply, a plurality of separate, repeating cut zones, and physical bonding between the base ply and the at least one top ply. The physical bonding is achieved by a technique selected from a group consisting of mechanical interlocking, thermal interlocking, and sonic welding. An individual label with an active portion is produced when the roll-fed label web is cut at the cut zones by a label application machine.

In another aspect, a roll-fed label web for a label with an active portion includes a base ply, at least one top ply, a plurality of separate, repeating cut zones, and a pattern of adhesive material on a selected one of a front surface of the base ply and a back surface of the at least one top ply. The pattern of adhesive material is selected from a group consisting of a pattern of adhesive material in at least one selected area and a continuous pattern. An individual label with an active portion is produced when the roll-fed label web is cut at the cut zones by a label application machine. The pattern of adhesive material additionally has an adhesive-free area thereby creating a window area.

In another aspect, a roll-fed label web for a label with an active portion includes a base ply, at least one top ply, a plurality of separate, repeating cut zones, and a release material on a selected one of a back surface of the at least one top ply and a front surface of the base ply. The release material is selected from a group consisting of a continuous flood coat of release material and a flood coat of release material in at least one selected area. An individual label with an active portion is produced when the roll-fed label web is cut at the cut zones by a label application machine.

In another aspect, a roll-fed label web for a label with an active portion includes a base ply, at least one top ply, a plurality of separate, repeating cut zones, and a plurality of separate, repeating bond areas between the base ply and the at least one top ply. The bond areas alternatively define a hinge and a release-reseal system. An individual label with an active portion is produced when the roll-fed label web is cut at the cut zones by a label application machine. The active portion is defined by an entire height of the label and is capable of opening in any desired direction.

In another aspect, a roll-fed label web for a label with an active portion includes a base ply, at least one top ply, a plurality of separate, repeating cut zones, and a plurality of separate, repeating bond areas between the base ply and the at least one top ply. The bond areas alternatively define a hinge and a release-reseal system. An individual label with an active portion is produced when the roll-fed label web is cut at the cut zones by a label application machine. The active portion is defined by at least one break path in the at least one top ply and is capable of opening in any desired direction. An accessory may be removably secured within the active portion.

In another aspect, a roll-fed label web for a label with an active portion includes a base ply, at least one top ply, a plurality of separate, repeating cut zones, and a plurality of separate, repeating bond areas between the base ply and the at least one top ply. The bond areas alternatively define a hinge and a release-reseal system. An individual label with an active portion is produced when the roll-fed label web is cut at the cut zones by a label application machine. The active portion includes at least one portion of the at least one top ply that may be removed to thereby create a window. The base ply may comprise a non-opaque material.

In another aspect, a roll-fed label web for a label with an active portion includes a base ply, at least one top ply, a plurality of separate, repeating cut zones, and a plurality of separate, repeating bond areas between the base ply and the at least one top ply. The bond areas alternatively define a hinge and a release-reseal system. An individual label with an active portion is produced when the roll-fed label web is cut at the cut zones by a label application machine. The active portion includes at least one portion of both of the base ply and the at least one top ply that may be removed, respectively. The base ply and the at least one top ply may both comprise opaque materials. The active portion, including at least one portion of both of the base ply and at least one top ply, may be removed as a single unit by way of a bonding means that joins together the at least one portion of both of the base ply and at least one top ply.

In another aspect, a roll-fed label web for a label with an active portion includes a base ply, at least one top ply, a plurality of separate, repeating cut zones, and a plurality of separate, repeating bond areas between the base ply and the at least one top ply. The bond areas alternatively define a hinge and a release-reseal system. An individual label with an active portion is produced when the roll-fed label web is cut at the cut zones by a label application machine. The active portion includes at least one break path in at least one portion of the base ply that in turn includes at least one portion of the base ply that may be transferred to a back surface of the at least one top ply by way of a bonding means that correspondingly joins together the at least one portion of the base ply with the back surface of the at least one top ply, upon opening the label. The at least one portion of the base ply that may be transferred to a back surface of the at least one top ply may be removed from the back surface of the at least one top ply in coupon-like fashion. The portion that may be transferred to a back surface of the at least one top ply enables the at least one top ply to be easily grasped to facilitate opening of the individual label.

In another aspect, a roll-fed label web for a label with an active portion includes a base ply, at least one top ply having at least one portion having dimensions that are substantially equivalent to the base ply and at least one portion having dimensions that are smaller than the base ply, a plurality of separate, repeating cut zones, and a plurality of separate, repeating bond areas between the base ply and the at least one top ply. The bond areas alternatively define a hinge and a release-reseal system. An individual label with an active portion is produced when the roll-fed label web is cut at the cut zones by a label application machine. The at least one portion of the at least one top ply has dimensions that are smaller than the base ply defines an underbite area to enable easy opening of the individual label.

In another aspect, a roll-fed label web for a label with an active portion includes at least one top ply, a base ply having at least one portion having dimensions that are substantially equivalent to the at least one top ply and at least one portion having dimensions that are smaller than the at least one top ply, a plurality of separate, repeating cut zones, and a plurality of separate, repeating bond areas between the base ply and the at least one top ply. The bond areas alternatively define a hinge and a release-reseal system. An individual label with an active portion is produced when the roll-fed label web is cut at the cut zones by a label application machine. The at least one portion of the base ply has dimensions that are smaller than the at least one top ply defines an overbite area to enable easy opening of the individual label.

In another aspect, a roll-fed label web for a label with an active portion includes a base ply, at least one top ply having at least one portion having dimensions that are smaller than the base ply and at least one portion having dimensions defining a lift tab, a plurality of separate, repeating cut zones, and a plurality of separate, repeating bond areas between the base ply and the at least one top ply. The bond areas alternatively define a hinge and a release-reseal system. An individual label with an active portion is produced when the roll-fed label web is cut at the cut zones by a label application machine. The at least one portion of the at least one top ply has dimensions defining a lift tab that enables easy opening of the individual label.

In another aspect, a roll-fed label web for a label with an active portion includes a base ply having a plurality of separate, repeating slits and cuts therethrough, at least one top ply having a plurality of separate, repeating cuts therethrough, in registration with the slits and cuts of the base ply, a plurality of separate, repeating cut lines proximate to each registration of the slits and cuts, and a plurality of separate, repeating bond areas between the base ply and the at least one top ply. The bond areas alternatively define a hinge and a release-reseal system. An individual label with an active portion is produced when the roll-fed label web is cut at the cut lines by a label application machine. The slits and cuts together define lift tabs to enable easy opening of individual labels.

In another aspect, a roll-fed label web for a label with an active portion includes a base ply having a plurality of separate, repeating slits therethrough, at least one top ply having a plurality of separate, repeating cuts therethrough, in registration with the slits of the base ply, a plurality of separate, repeating cut lines proximate to each registration of the slits and cuts, and a plurality of separate, repeating bond areas between the base ply and the at least one top ply. The bond areas alternatively define a hinge and a release-reseal system. An individual label with an active portion is produced when the roll-fed label web is cut at the cut lines by a label application machine. The slits and cuts together define lift tabs to enable easy opening of individual labels.

In another aspect, a roll-fed label web for a label with an active portion includes a base ply having a plurality of separate, repeating holes therethrough, at least one top ply, a plurality of separate, repeating cut lines proximate to each of the plurality of separate, repeating holes in the base ply, and a plurality of separate, repeating bond areas between the base ply and the at least one top ply. The bond areas alternatively define a hinge and a release-reseal system. An individual label with an active portion is produced when the roll-fed label web is cut at the cut lines by a label application machine. The holes define lift voids to enable easy opening of individual labels.

In another aspect, a roll-fed label web for a label with an active portion includes a microburst feature.

In another aspect, a roll-fed label web for a label with an active portion includes a scratch-and-sniff feature.

### BRIEF DESCRIPTION OF THE DRAWINGS

FIG. 1 is a cross-sectional illustration of a portion of a label web.

FIG. 1a is a cross-sectional view of an example of a single label with an active portion, cut from the web of FIG. 1.

FIG. 2 is a cross-sectional illustration of another example of a label web for a label with an active portion.

FIG. 2a is a cross-sectional view of an example of a single label with an active portion, cut from the web of FIG. 2.

FIG. 2b is an illustration of the label of FIG. 2a, adhered to a container.

FIG. 2c is a cross-sectional illustration of another example of a single label with an active portion.

FIG. 2d is a cross-sectional illustration of another example of a single label with an active portion.

FIG. 3 is a cross-sectional illustration of another embodiment of a label with an active portion.

FIG. 3a is an illustration of the label of FIG. 3, adhered to a container.

FIG. 3b is an illustration of the label of FIG. 3a, having been subsequently opened.

FIG. 4 is a cross-sectional illustration of another embodiment of a label with an active portion.

FIG. 5 is a top view illustration of an example of a base ply in a portion of a web providing a label with an active portion.

FIG. 5a is a top view illustration of another example of a base ply in a portion of a web providing a label with an active portion.

FIG. 5b is a top view illustration of another example of a base ply in a portion of a web providing a label with an active portion.

FIG. 5c is a top view illustration of another example of a base ply in a portion of a web providing a label with an active portion.

FIG. 5d is a top view illustration of another example of a base ply in a portion of a web providing a label with an active portion.

FIG. 6 is a top view illustration of an example of a top ply in a portion of a web providing a label with an active portion.

FIG. 6a is a top view illustration of another example of a top ply in a portion of a web providing a label with an active portion.

FIG. 7 is a top view illustration of an embodiment of a partially opened label with an active portion.

FIG. 7a is a top view illustration of another embodiment of a partially opened label with an active portion.

FIG. 7b is a top view illustration of an embodiment of a fully opened label with an active portion.

FIG. 8 is an illustration of the label of FIG. 7b, adhered to a container.

FIG. 8a is an illustration of the label of FIG. 7b with an accessory, adhered to a container.

FIG. 9 is a top view illustration of another embodiment of a partially opened label with an active portion.

FIG. 10 is a top view illustration of another embodiment of a partially opened label with an active portion.

FIG. 10a is an illustration of the label of FIG. 10, adhered to a container.

FIG. 11 is a top view illustration of another embodiment of a partially opened label with an active portion.

FIG. 11a is a top view illustration of the label of FIG. 11 in a nearly closed condition.

FIG. 11b is a top view illustration of another embodiment of a partially opened label with an active portion.

FIG. 11c is a top view illustration of another embodiment of a partially opened label with an active portion.

FIG. 12 is a top view illustration of another embodiment of a partially opened label with an active portion.

FIG. 13 is a top view illustration of another embodiment of a label with an active portion.

FIG. 14 is a top view illustration of another embodiment of a label with an active portion.

FIG. 15 is a top view illustration of an example of a portion of a label web for a label with an active portion.

FIG. 15a is a top view illustration of another example of a portion of a label web for a label with an active portion.

FIG. 16 is a top view illustration of another embodiment of a partially opened label with an active portion.

FIG. 17 is a top view illustration of another example of a portion of a label web for a label with an active portion.

FIG. 18 is a progressive top view illustration of corresponding portions of label webs in an example of construction of a label with an active portion.

FIG. 18a is a progressive top view illustration of corresponding portions of label webs in another example of construction of a label with an active portion.

FIG. 18b is a progressive top view illustration of corresponding portions of label webs in another example of construction of a label with an active portion.

### DETAILED DESCRIPTION

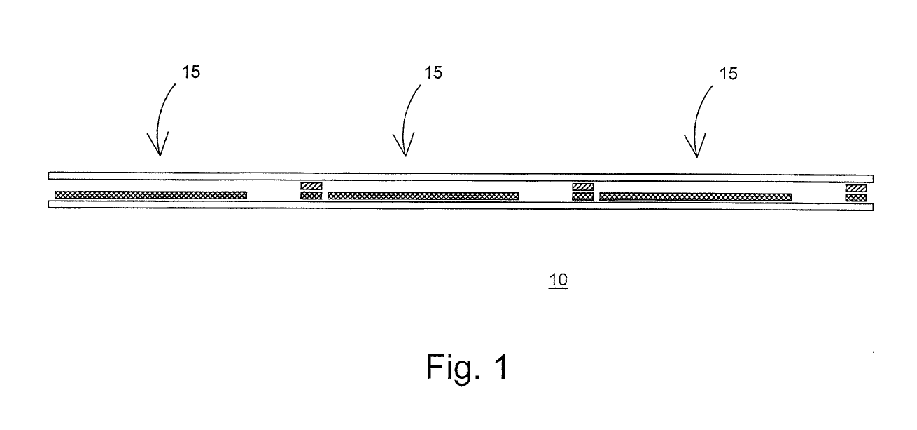

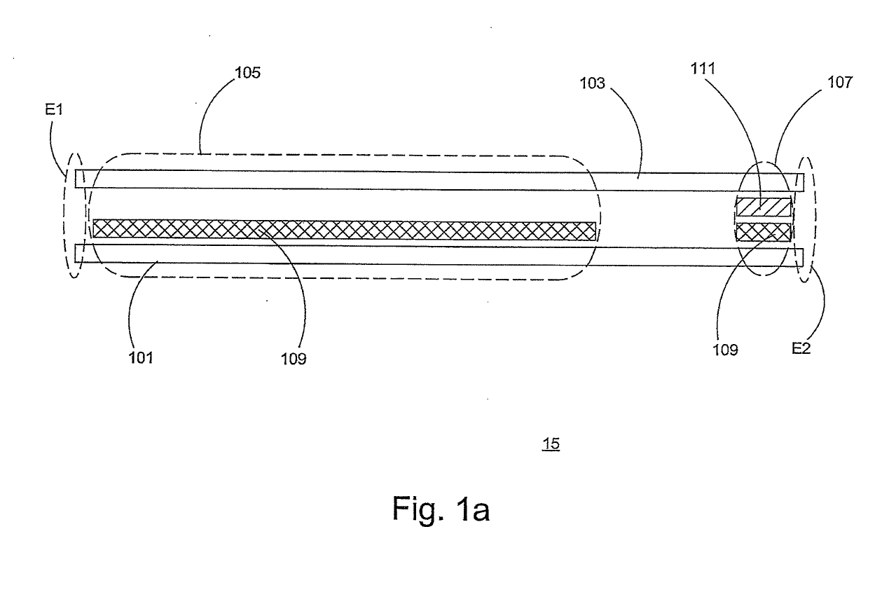

One embodiment of a label with an active portion is illustrated in FIGS. 1 and 1a, in cross-section as a portion of a label web and as a separate, individual label cut from the web, respectively. The label web includes a top ply, a base ply, two separate, repeating bond areas between the plies each comprising a hinge and a release-reseal system, and cut zones. The bond areas between the plies are set back from the cut zones. These set backs are desirable and advantageous in use with roll-fed label application equipment, in aiding prevention of adhesive material from deleteriously building up on, interfering, or otherwise unintentionally coming into contact with cutting implements in the application equipment.

As used throughout this disclosure, the term “active portion” refers to a portion of a label that is intended to be manipulated by, typically, a consumer or end-user to access information or graphics in, e.g., booklet type label fashion.

It is to be noted that a label with an active portion, for application to an object to be labeled utilizing separately supplied adhesive material with a roll-fed label application machine, includes a base ply and at least one top ply. The term “top ply”, as used herein, refers to any ply above the base ply in the label structures and of which there may be more than one. The base ply has a first lengthwise dimension, a first widthwise dimension, a front surface that is capable of bearing graphic images and coatings, and an adhesive-free back surface that is also capable of bearing graphic images and coatings and capable of being adhesively coupled to an object to be labeled using separately supplied adhesive material at point of application. The at least one top ply has a second lengthwise dimension, a second widthwise dimension, a front surface that is capable of bearing graphic images and coatings, and a back surface that is also capable of bearing graphic images and coatings. The base ply and the at least one top ply are adhesively coupled, in a first portion of the label, to each other such that the front surface of the base ply and the back surface of the at least one top ply are preferably, but not necessarily, in contiguous juxtaposition with each other along the first lengthwise dimension and the second lengthwise dimension, respectively, and along the first widthwise dimension and the second widthwise dimension, respectively. Also, the base ply and the at least one top ply are preferably, but not necessarily, in a second portion of the label, releasably and resealably coupled to each other. As indicated above, when manufactured and prior to being applied to an object of interest to be labeled, the back surface of the base ply is free of adhesive material. In this state, it can then be supplied as a continuous web in roll form to a conventional roll-fed label application machine.

It is to be understood that any ply in a label with an active portion may be a single ply of material, whether coated or uncoated, a so-called clear protective laminate construction, or any laminated, combined ply, or co-extruded construction.

With particular reference to FIG. 1a, a cross-sectional view of an example of a single label with an active portion 15 cut from web 10 of FIG. 1 is illustrated. Label 15 includes a base ply 101, a top ply 103, two separate bond areas represented by a hinge portion 105 and a release-reseal portion 107, and opposing ends E1 and E2 resulting from cuts made in respective cut zones in web 10 by an application machine. The cut zones are not specifically illustrated; but it is to be understood that they would be proximate to those areas in the drawing where adhesive material 109 is not present. Hinge portion 105 includes adhesive material 109; and release-reseal portion 107 includes adhesive material 109 and release material 111.

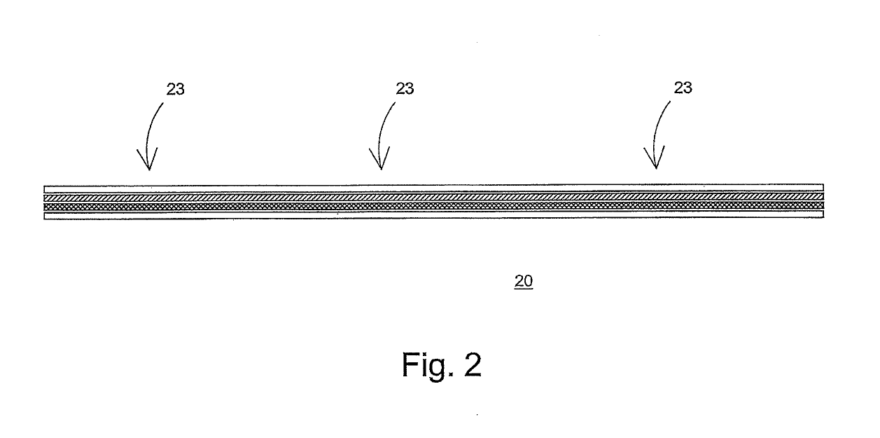

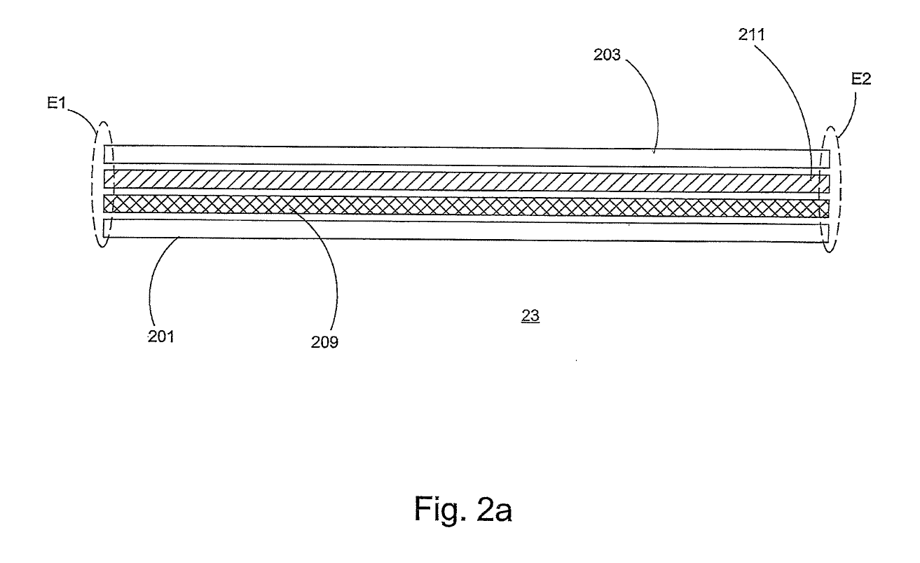

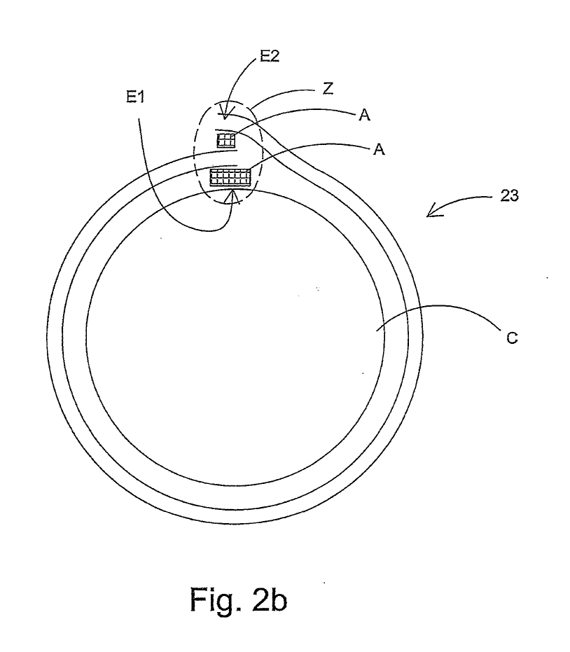

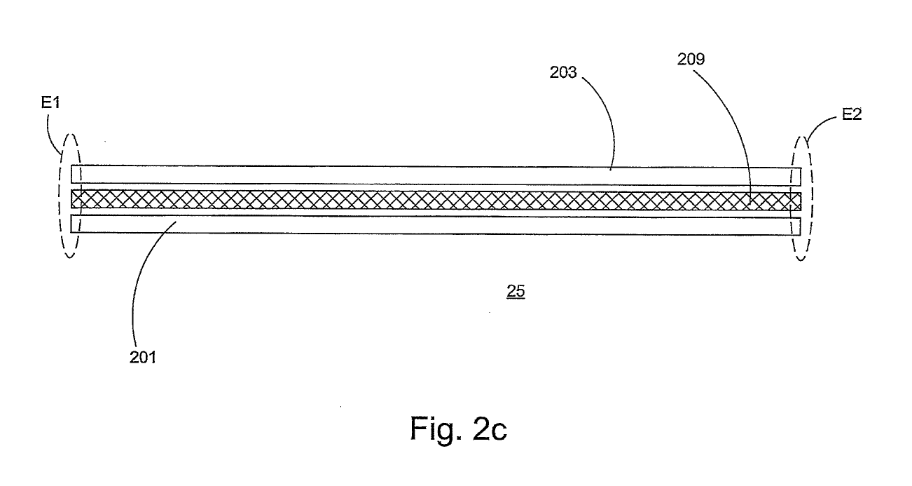

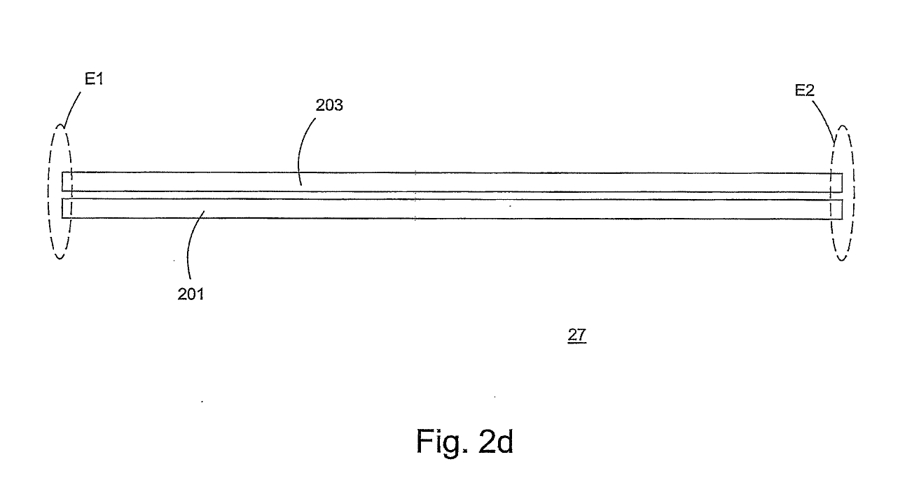

FIG. 2 is a cross-sectional illustration of another example of a label web 20 for a label with an active portion 23, incorporating flood coats of adhesive and release materials between a top ply and a base ply.

With particular reference to FIG. 2a, a cross-sectional view of an example of a single label with an active portion 23 cut from web 20 of FIG. 2 is illustrated. Label 23 includes a base ply 201, a top ply 203, and opposing ends E1 and E2 resulting from cuts made in respective cut zones (not illustrated) in web 20 by an application machine. Label 23 also includes flood coats of adhesive material 209 and release material 211.

FIG. 2b depicts the embodiment of label 23 shown in FIG. 2a as adhered to a container C with adhesive material (A) separately supplied, at point of application, by labeling equipment. As known in the roll-fed label art and as shown in the drawing, it is usual and customary to allow or provide for some slight overlap. As so applied, ends E1 and E2 of label 23 create an overlap zone (Z) which thereby permits top ply 203 as the active portion of label 23 to open to no more than approximately an area around or in the overlap zone Z. It is to be understood that this overlap zone feature thus effectively creates a hinge portion in label 23 when so adhered to an object.

FIG. 2c is a cross-sectional illustration of another example of a single label with an active portion 25. Label 25 includes a base ply 201, a top ply 203, and opposing ends E1 and E2 resulting from cuts made in respective cut zones (not illustrated) in a web by an application machine. Label 25 also includes a flood coat of adhesive material 209. It is to be appreciated, in this example of a label with an active portion, that no release material is present. In such an example that intentionally omits release material, the label may, for example, utilize an adhesive material that is relatively less aggressive as compared to other adhesive materials used in constructing other embodiments of a label with an active portion. Further, such a label constructed without release material could additionally, or alternatively, utilize a ply material that inherently has a release property.

FIG. 2d is a cross-sectional illustration of another example of a single label with an active portion 27. Label 27 includes a base ply 201, a top ply 203, and opposing ends E1 and E2 resulting from cuts made in respective cut zones (not illustrated) in a web by an application machine. It is to be appreciated, in this example of a label with an active portion, that neither adhesive nor release materials are present. In such an example that intentionally omits both adhesive material and release material, the label may, for example, utilize cling-like materials for one or both plies 201 and 203.

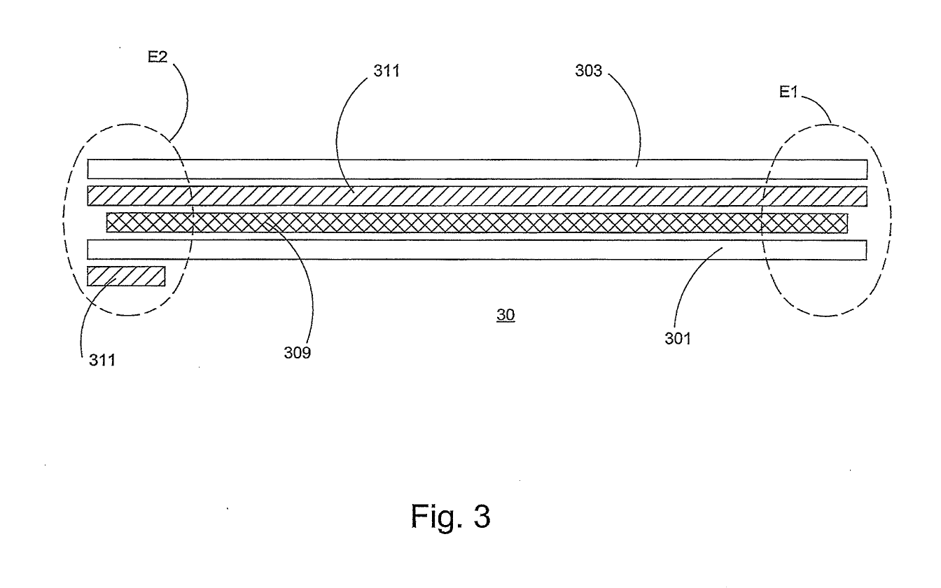

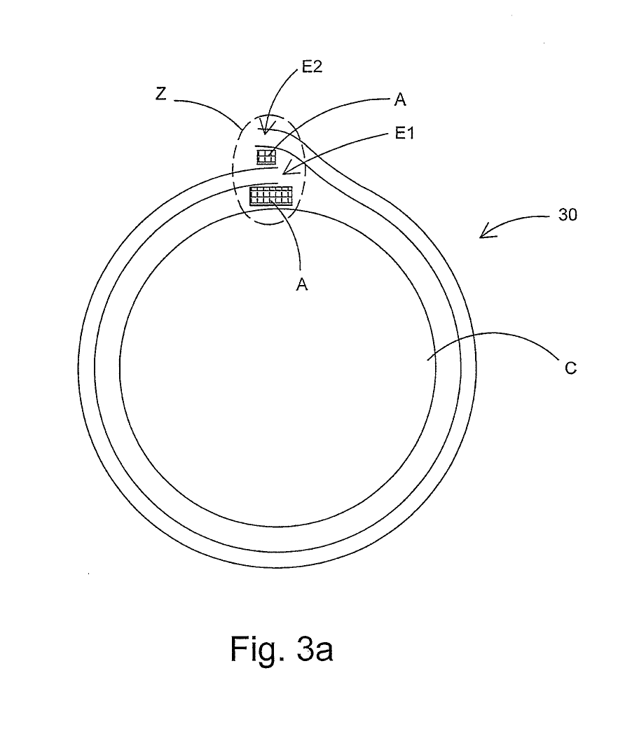

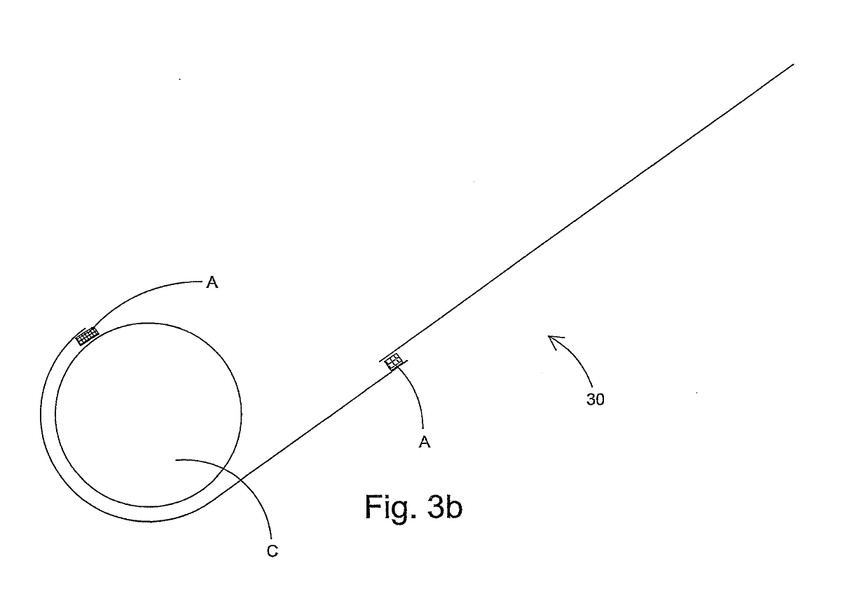

FIG. 3 is a cross-sectional illustration of another embodiment of a label with an active portion 30. Therein, label 30 includes a base ply 301, a top ply 303, a release-reseal system comprising adhesive material 309 and release material 311, and opposing ends E1 and E2 resulting from cuts made at respective cut zones. The cut zones are not specifically illustrated; but it is to be understood that they would be proximate to those areas in the drawing where adhesive material 309 is not present. End E2 also includes a selected amount of release material 311 on a back surface of base ply 301. It is to be understood that in some embodiments, e.g., similar to label 23 shown in FIG. 2a, label 30 could also be constructed without provision of adhesive-free cut zones. Such embodiments without adhesive-free cut zones could be satisfactory when performance of a particular label application machine would not be negatively affected by presence of adhesive materials.

FIG. 3a depicts the embodiment of label 30 shown in FIG. 3 as adhered to a container C with adhesive material (A) separately supplied, at point of application, by labeling equipment. As known in the roll-fed label art and as shown in the drawing, it is usual and customary to allow or provide for some slight overlap. As so applied, ends E1 and E2 of label 30 create an overlap zone (Z) which thereby permits top ply 303 to open to no more than approximately an area around or in the overlap zone Z.

It is to be understood that this overlap zone feature could thus effectively create a hinge portion in label 30 when so adhered to an object. Specifically, it is to be understood that in a label with an active portion utilizing an overlap zone Z created at point of application, a hinge could in some circumstances be omitted from the label's internal structure since the overlap zone Z could itself provide a hinge function.

It is also to be understood that application of end E1 to container C—and subsequent encircling of container C by label 30—could enable end E1, and release material 311 on the back surface of base ply 301 at end E2, to be proximate and releasably coupled to a front surface of top ply 303. It is also to be understood that this relatively small amount of release material 311 shown in FIG. 3 on the back surface of ply 301 could alternatively be provided on any portion, or all portions, of the back surface of base ply 301 and the front surface of top ply 303.

FIG. 3b depicts label 30 of FIG. 3a as having been subsequently opened by, e.g., a consumer or end-user. It is to be understood that such an embodiment of a label with an active portion could ultimately be opened to a point where the label is adhered to the container and then resealed by re-encircling the label around the container; and that therefore a relatively large amount of available surface area (e.g., for desired graphics) could be provided by such a construction.

It is also to be understood that a particular embodiment of a label with an active portion could intentionally omit release material and instead utilize a ply material that inherently has a release property where the release material would otherwise be present. Furthermore, an adhesive material having a sufficiently low aggressiveness (e.g., a removable or low-tack adhesive material) could be utilized at point of application for a label with an active portion having a ply material (e.g., paper or film) without an inherent release property or coating. In such an application, the adhesive material at point of application of sufficiently low aggressiveness could inhibit destruction of the ply material while still maintaining releasability and resealability of the active portion of the label.

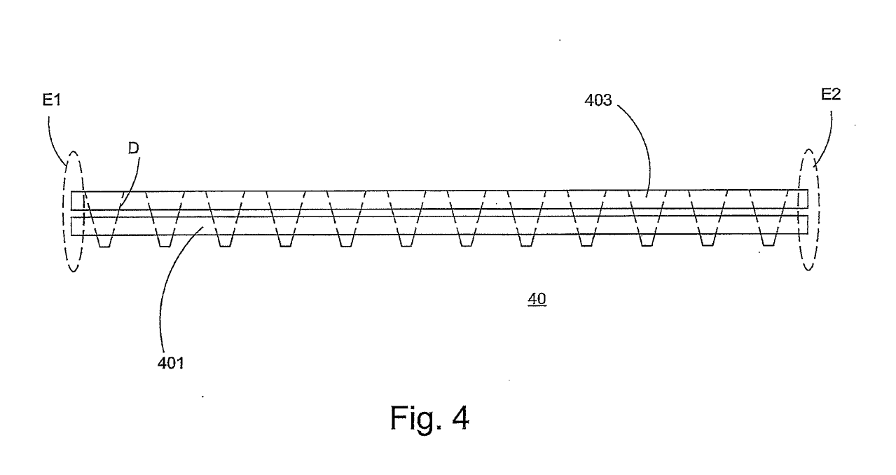

FIG. 4 is a cross-sectional illustration of another embodiment of a label with an active portion 40. Therein, label 40 includes a base ply 401, a top ply 403, and physical bonding between plies 401 and 403 by way of selected physical mating deformation (D). It is to be appreciated and understood that this physical bonding may be achieved without a need for adhesive material within the label, between the plies. Label 40 may also include opposing ends E1 and E2 resulting from cuts made at respective cut zones (not illustrated) in a web of labels 40 by an application machine.

In one example of physical bonding, a label web could be passed through a male-female pinch roller assembly to create mating deformation and thus mechanical interlocking of the plies. In another example of physical bonding, heat may be used to bond the plies by way of a thermal interlocking reaction. In yet another example, physical bonding of the plies could be achieved by sonically sealing them together in a process commonly termed “sonic welding”.

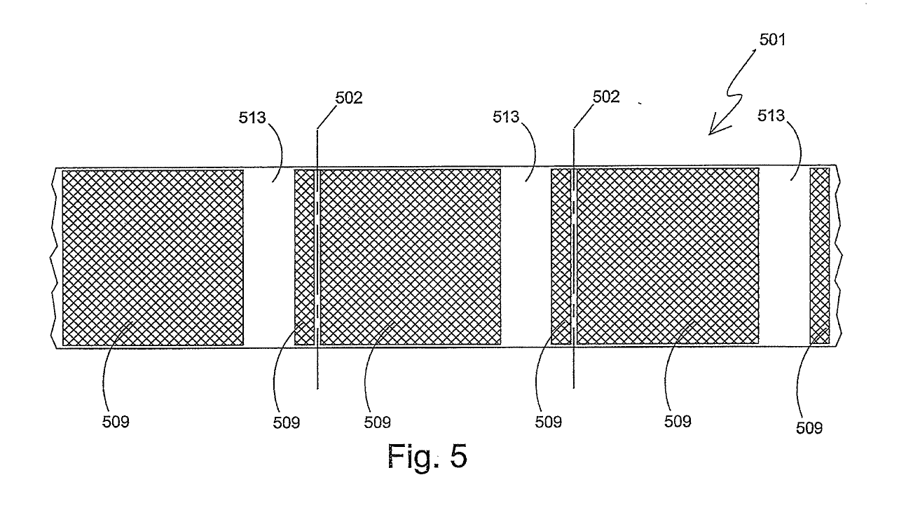

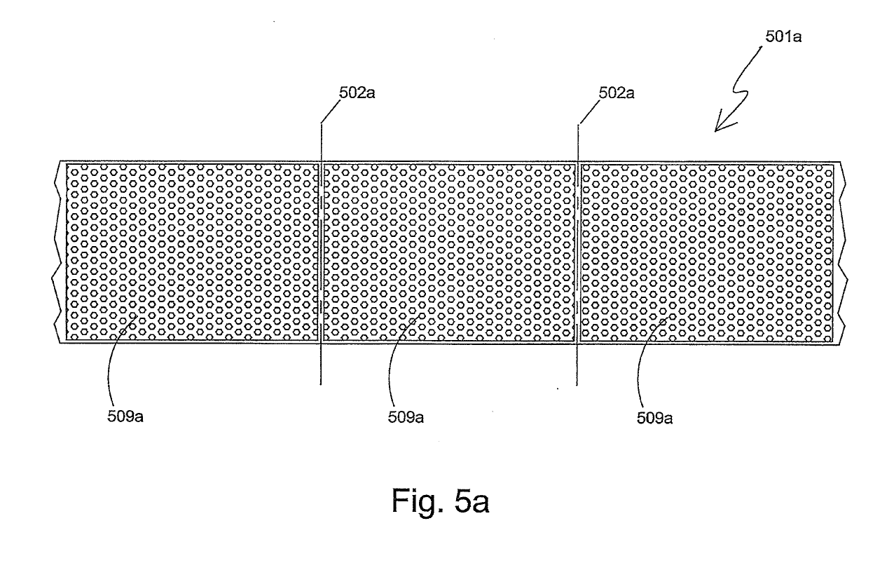

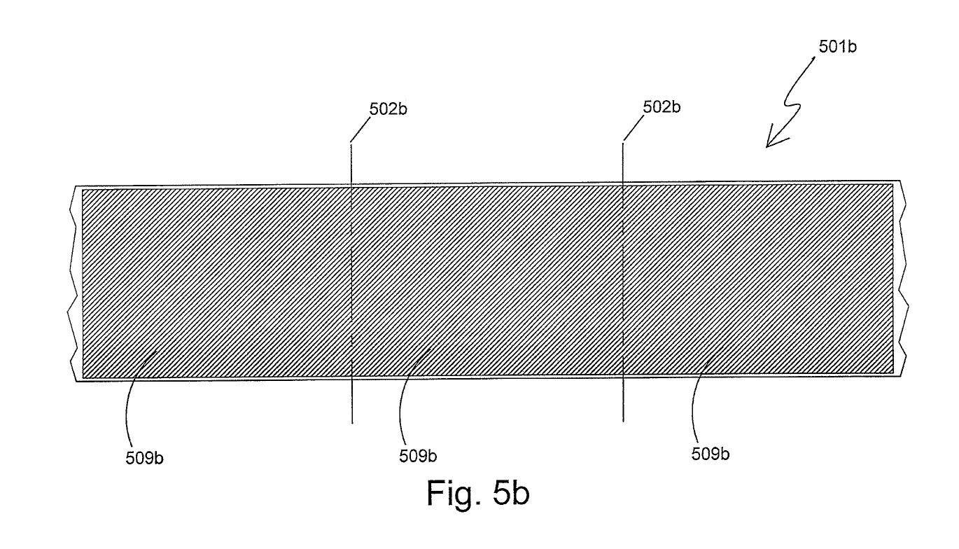

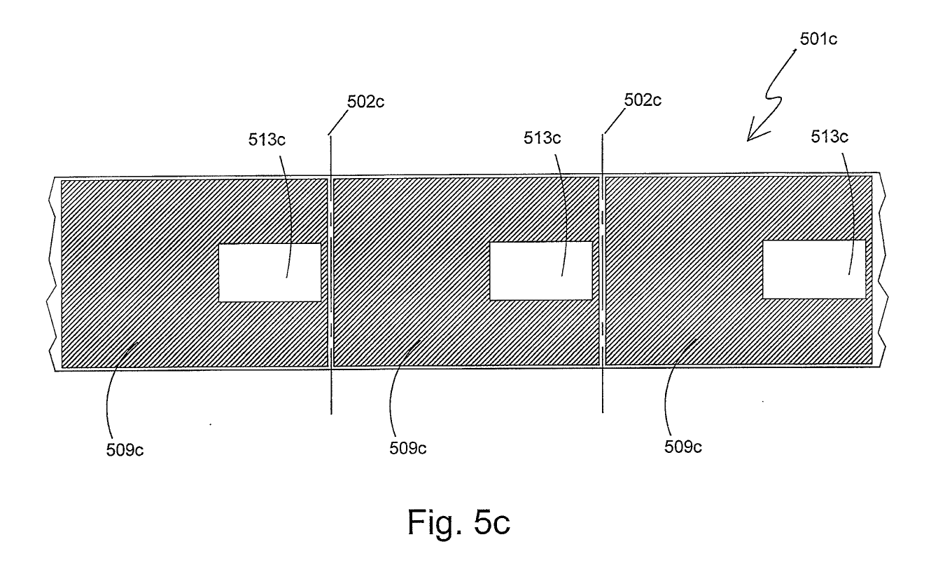

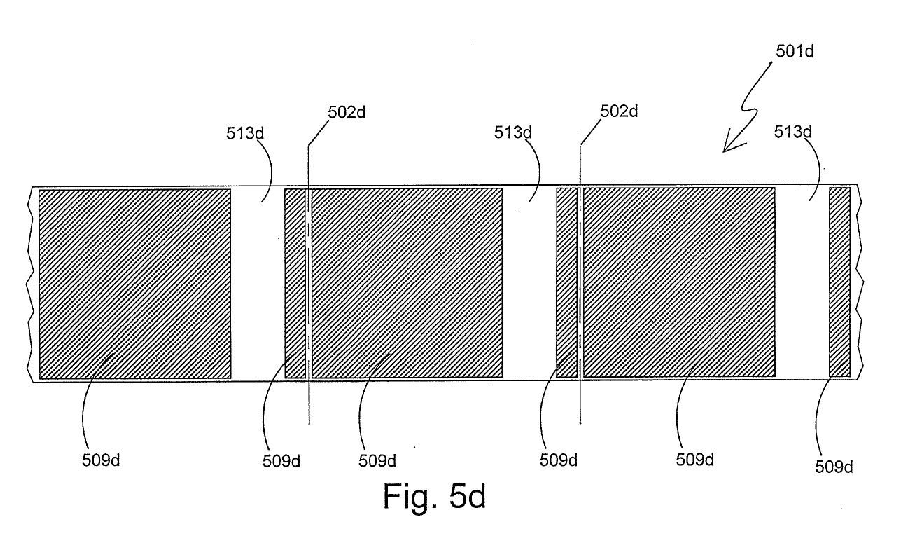

FIGS. 5, 5a, and 5b are illustrations of alternative embodiments of base plies 501, 501a, and 501b, respectively, in a portion of a web providing a label with an active portion.

Each of base plies 501, 501a, and 501b have a pattern of adhesive material 509, 509a, and 509b, respectively. The adhesive patterns may take any desirable form. As shown in FIG. 5, adhesive material 509 is provided on base ply 501 in a pattern approximately corresponding to that of adhesive material 209 in FIGS. 1 and 2, with an adhesive-free area 513; in FIG. 5a, adhesive material 509a is provided in a continuous pattern on base ply 501a; and in FIG. 5b, adhesive material 509b is provided in flood-coat fashion on base ply 501b.

FIG. 5c is an illustration of another embodiment of a portion of a web providing a label with an active portion, showing base ply 501c with a pattern of adhesive material 509c resulting in an adhesive-free area 513c creating a “window” area.

FIG. 5d is an illustration of another embodiment of a portion of a web providing a label with an active portion, showing base ply 501d with a plurality of areas 509d having a flood coat of an adhesive material, with adhesive-free areas 513d.

It is to be understood that, as used herein, the terms “pattern” and “flood coat” may, in a particular embodiment, pertain to any coating or material that is provided across an entire surface, or substantially so, of a ply material—or within any desired boundaries or margins about the ply material.

In FIGS. 5, 5a, 5c, and 5d, respective cut lines 502, 502a, 502c, and 502d are illustrated within their associated cut zones where no adhesive material is present. It is again to be understood, however, that in some embodiments the labels could also be constructed with cut zones that are not free of adhesive materials (e.g., with respect to cut lines 502b in FIG. 5b) when performance of a particular label application machine would not be negatively affected by presence of adhesive materials.

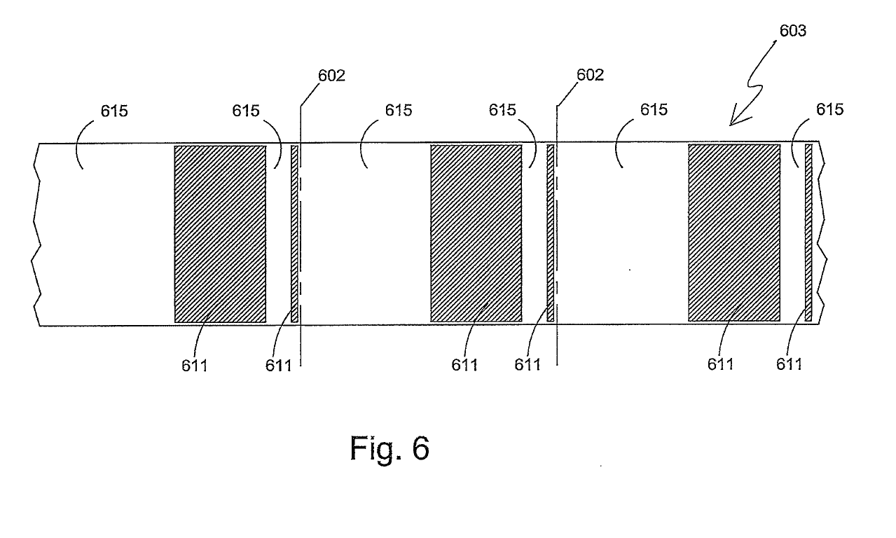

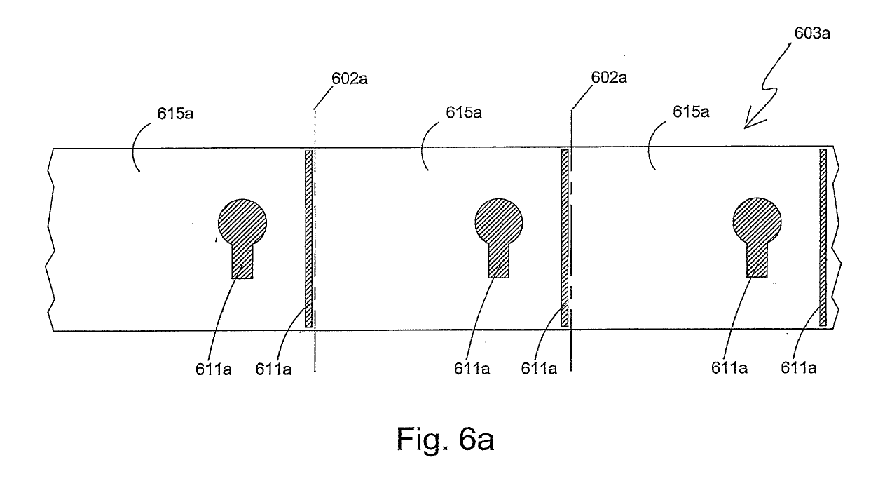

FIG. 6 is an illustration of a portion of a web in construction of a label with an active portion, showing a back surface of top ply 603 with a plurality of patterns of release materials 611. These patterns result in, correspondingly, a plurality of areas 615 within which no release material is present.

FIG. 6a is an illustration of a portion of a web in construction of a label with an active portion, showing a back surface of top ply 603a with a plurality of patterns of release materials 611a. These patterns result in, correspondingly, irregularly-shaped areas 615a within which no release material is present.

It is to again be appreciated and understood that patterns of adhesive materials and release materials employed to provide various embodiments of a label with an active portion may take any desirable form or configuration; and that regardless of a particular pattern of adhesive material or release material, a label with an active portion may selectively have defined adhesive-free cut zones where no adhesive material is present or the adhesive material is set back therefrom. Thus advantageously, as aforesaid, the adhesive-free cut zones could aid in preventing adhesive material from coming into contact with cutting implements in roll-fed label application equipment. For example, in FIGS. 5, 5a, 5c, 5d, 6, and 6a, such adhesive-free cut zones and corresponding cut lines, where the web may be cut by a roll-fed label application machine, are identified by reference numerals 502, 502a, 502c, 502d, 602, and 602a, respectively. Although not illustrated, it is again to be appreciated that release material of a label with an active portion (e.g., 311 in FIG. 3) could also be provided in the labels alternatively as a pattern, whether fully or partially across a ply or plies.

Although not illustrated, it is to be understood that the adhesive materials could alternatively be provided on back surfaces of the top plies as well as the front surfaces of the base plies, or both. Similarly, the release materials could alternatively be provided on back surfaces of the top plies as well as the front surfaces of the base plies, or both.

It is again to be understood that cut zones may be adhesive-free as aforedescribed or may include adhesive material (e.g., FIG. 5b) in a particular embodiment when performance of a particular label application machine would not be negatively affected by presence of adhesive materials. Such an application machine could, for example, employ non-mechanical contact cutting by way of a laser.

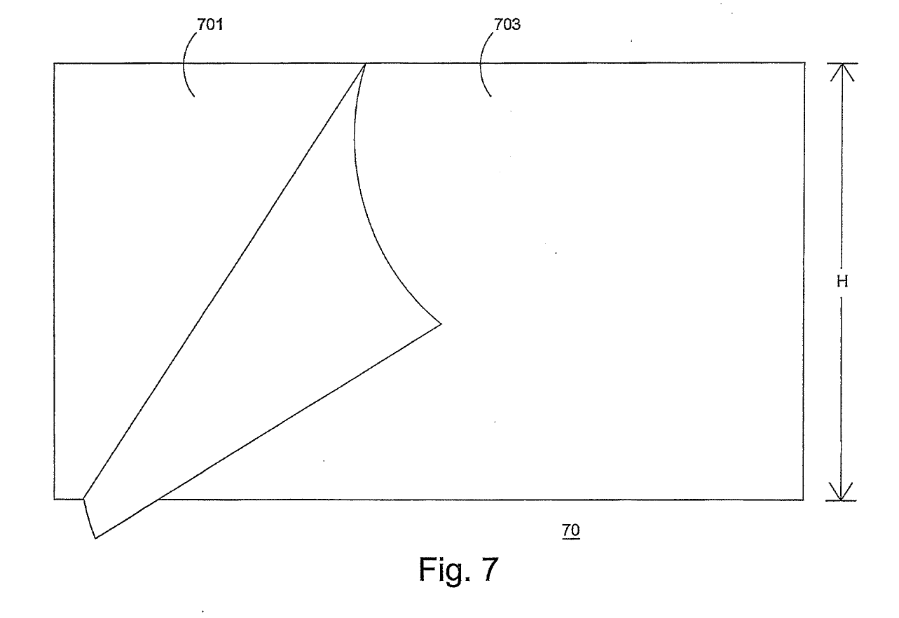

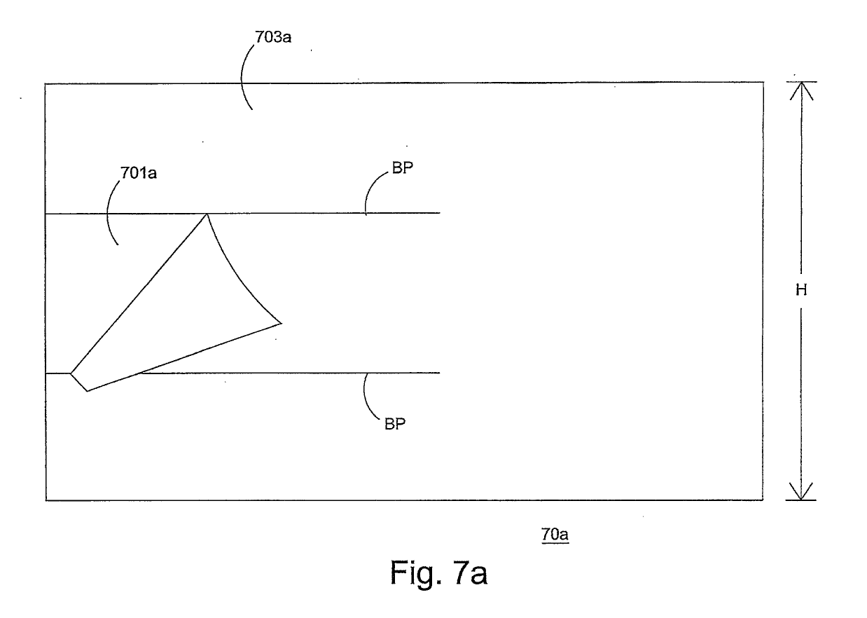

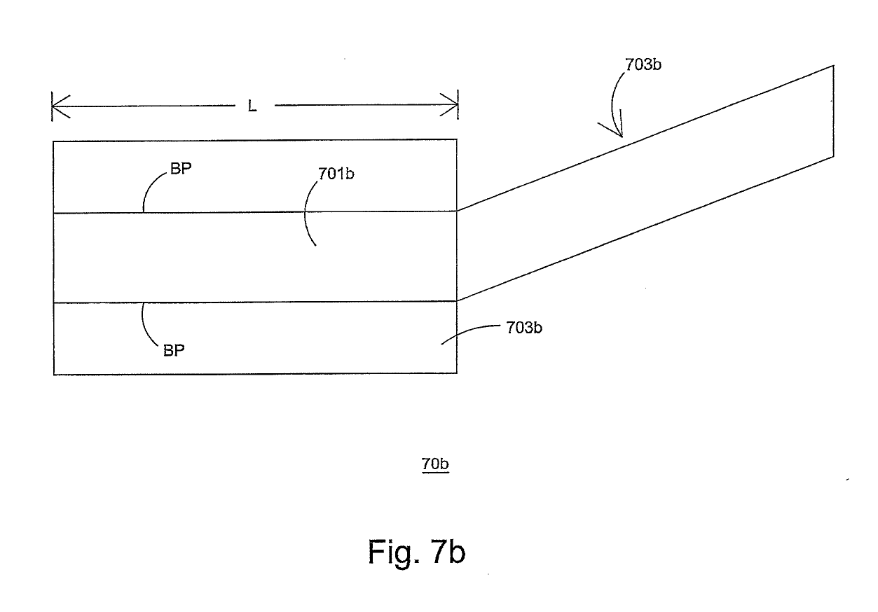

FIG. 7 is a top view illustration of another embodiment of a partially opened label with an active portion 70. Label 70 includes a base ply 701, a top ply 703, a hinge (not illustrated) comprising an adhesive material between plies 701 and 703, and a release-reseal system (not illustrated) comprising corresponding adhesive material and release material between plies 701 and 703. It is to be appreciated in this embodiment that an entire height H, and any length, of label 70 could serve as an active portion and be provided to open in any desired direction.

FIG. 7a is a top view illustration of another embodiment of a partially opened label with an active portion 70a. Label 70a includes a base ply 701a, a top ply 703a that is selectively cut by defining a desired break path (BP), e.g., a slit, a cut, a perforation, a score, or a break, by means of, e.g., a steel knife, a heating element, a laser, or a die-cutting process; or, a printed instruction to an end-user to use a cutting implement such as scissors. Label 70a also includes a hinge (not illustrated) comprising an adhesive material between plies 701a and 703a, and a release-reseal system (not illustrated) comprising corresponding adhesive material and release material between plies 701a and 703a. It is to be appreciated therefore that any selected portion of height H of a label could serve as an active portion and be provided to open in any desired direction.

FIG. 7b is a top view illustration of another embodiment of a fully opened label with an active portion 70b. Label 70b includes a base ply 701b, a top ply 703b that is selectively cut by defining a desired break path (BP), e.g., a slit, a cut, a perforation, a score, or a break, by means of, e.g., a steel knife, a heating element, a laser, or a die-cutting process; or, a printed instruction to an end-user to use a cutting implement such as a scissors. Label 70b also includes a hinge (not illustrated) comprising an adhesive material between plies 701b and 703b, and a release-reseal system (not illustrated) comprising corresponding adhesive material and release material between plies 701b and 703b. It is to be appreciated therefore that any selected portion of a length L of a label (for example, an entire length L as shown in the drawing) could serve as an active portion and be provided to open in any desired direction, with break paths BP in top ply 703b being adjusted accordingly.

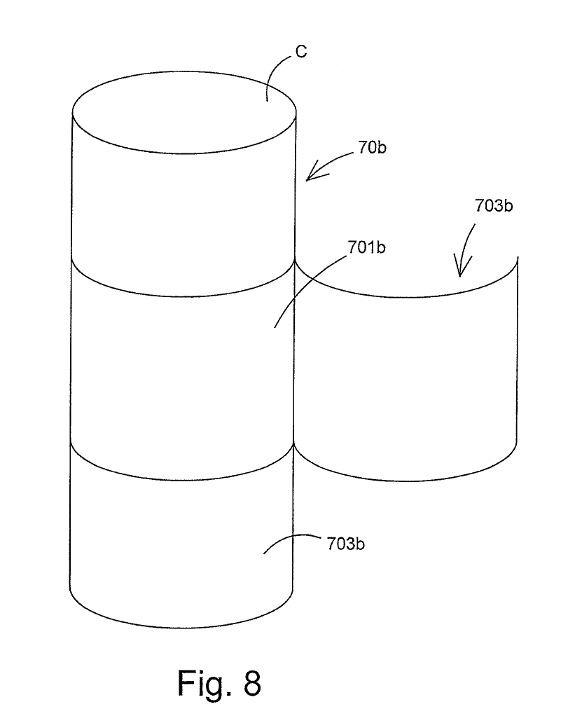

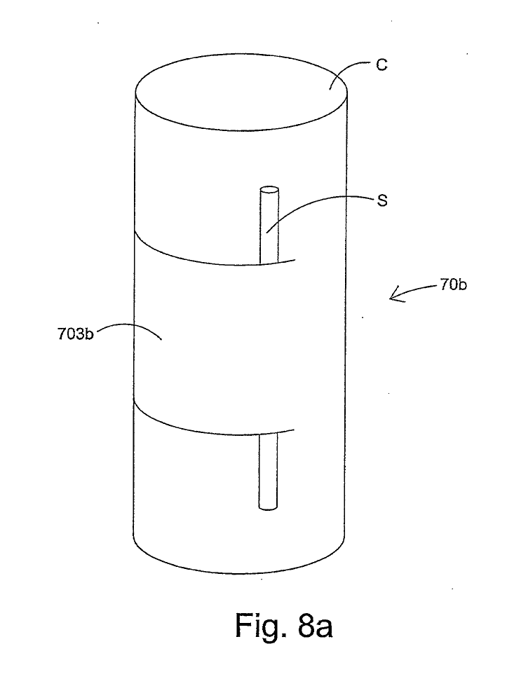

In FIG. 8, label 70b is illustrated as having been applied to a container C. In FIG. 8a, label 70b is again illustrated as having been applied to container C with, additionally, an accessory such as a conduit or straw S removably secured within an active portion of label 70b defined by plies 703b and 701b (visible in FIG. 8) therebetween.

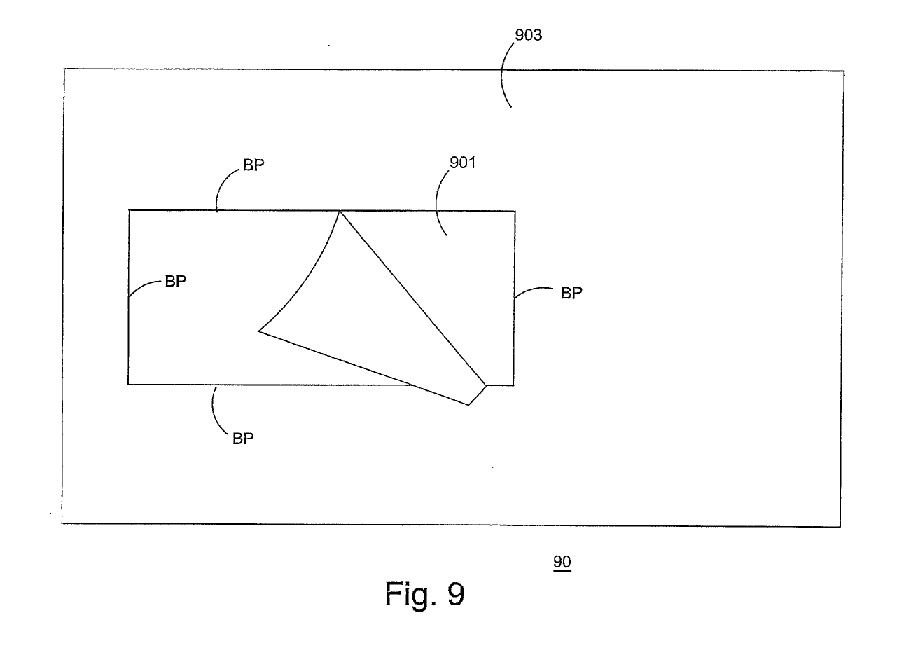

FIG. 9 is a top view illustration of another embodiment of a partially opened label with an active portion 90. Label 90 includes a base ply 901, a top ply 903 that is selectively cut by defining a desired break path (BP), e.g., a slit, a cut, a perforation, a score, or a break, by means of, e.g., a steel knife, a heating element, a laser, or a die-cutting process; or, a printed instruction to an end-user to use a cutting implement such as a scissors. Label 90 also includes a hinge (not illustrated) comprising an adhesive material between plies 901 and 903, and a release-reseal system (not illustrated) comprising corresponding adhesive material and release material between plies 901 and 903. It is to be appreciated therefore that any selected portion of a label could serve as an active portion and be provided from an interior portion of the label toward any end thereof, and be provided to open in any desired direction. Furthermore, such a label could omit the hinge with the active portion thus comprising, for example, a coupon that could be provided in any orientation and in any portion of one or more plies (e.g., base ply 901, top ply 903, or both plies). In a coupon embodiment the active portion could, for example, be removed by a consumer or end-user.

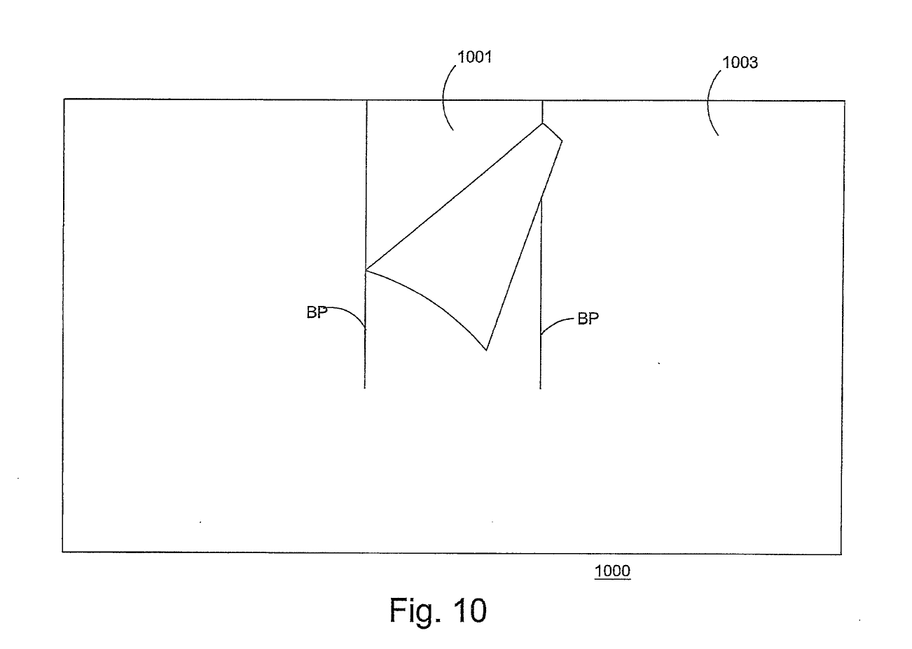

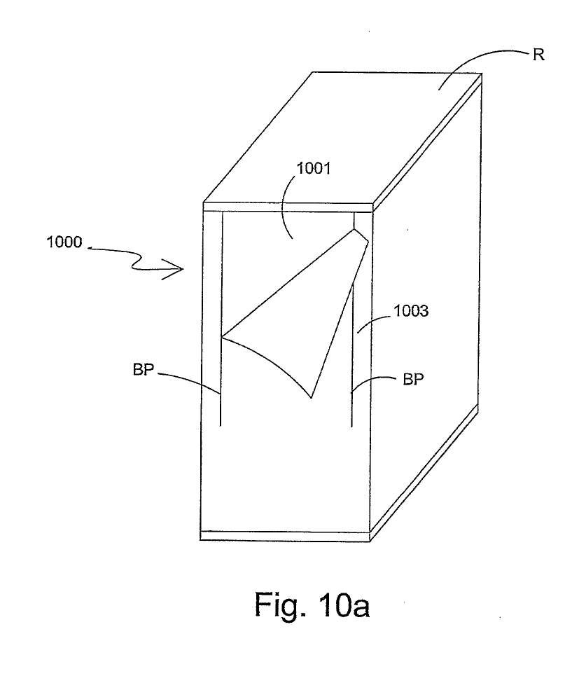

FIG. 10 is a top view illustration of another embodiment of a partially opened label with an active portion 1000. Label 1000 includes a base ply 1001, a top ply 1003 that is selectively cut by defining a desired break path (BP), e.g., a slit, a cut, a perforation, a score, or a break, by means of, e.g., a steel knife, a heating element, a laser, or a die-cutting process; or, a printed instruction to an end-user to use a cutting implement such as a scissors. Label 1000 also includes a hinge (not illustrated) comprising an adhesive material between plies 1001 and 1003, and a release-reseal system (not illustrated) comprising corresponding adhesive material and release material between plies 1001 and 1003. It is to be appreciated therefore that any selected portion of a label could serve as an active portion and be provided in, e.g., top-down fashion as shown in the drawing for, e.g., a non-cylindrical container R as shown in FIG. 10a, or be provided to open in any desired direction.

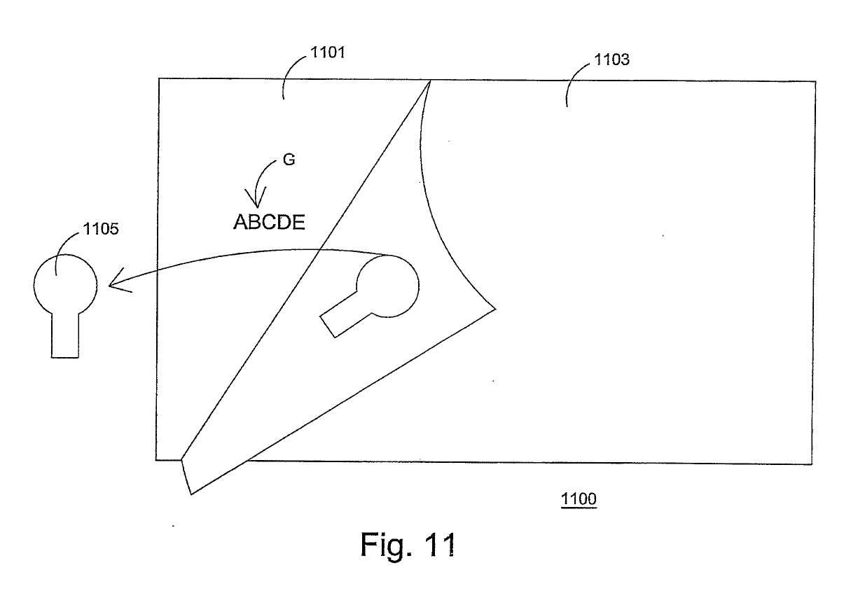

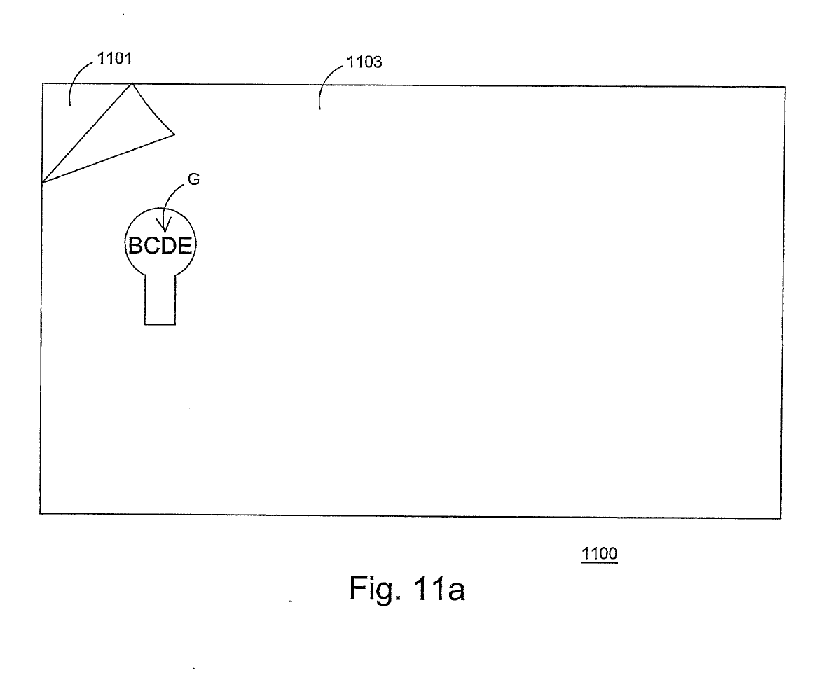

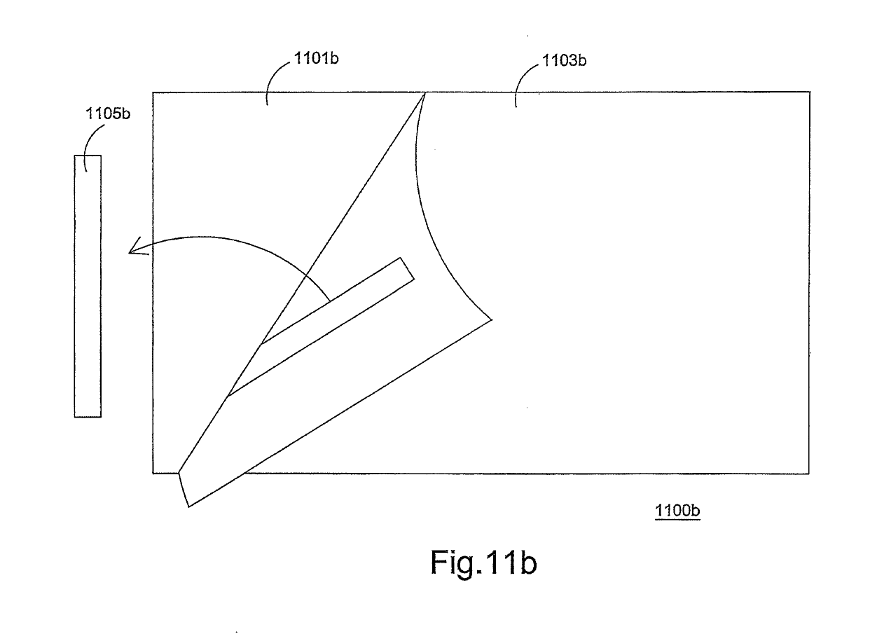

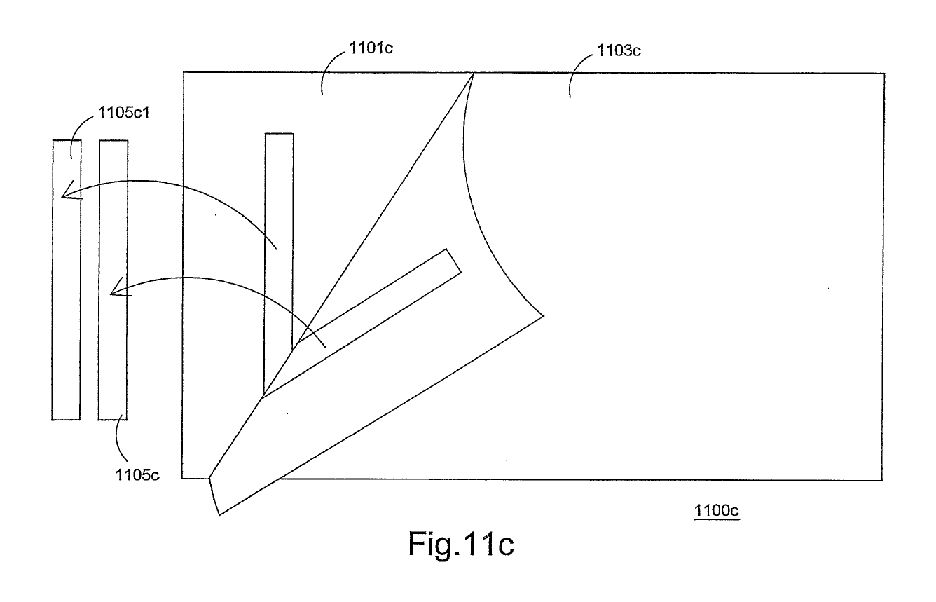

FIG. 11 is a top view illustration of another embodiment of a partially opened label with an active portion 1100. Label 1100 includes a base ply 1101, a top ply 1103, a hinge (not illustrated) comprising an adhesive material between plies 1101 and 1103, and a release-reseal system (not illustrated) comprising corresponding adhesive material and release material between plies 1101 and 1103. In this embodiment, for purpose of illustration, graphics G are shown. Also in this embodiment, the active portion further comprises a portion 1105 of ply 1103 that may be removed to create a “window” to the base ply as shown in FIG. 11a with label 1100 in a nearly closed condition.

Additionally, in a label with an active portion 1100b as shown in FIG. 11b, if base ply 1101b was provided as a non-opaque material, then upon removing portion 1105b from top ply 1103b a consumer or end-user could be able to, for example, visually observe a level of a product within a non-opaque container to which the label is adhered.

Further, in a label with an active portion 1100c as shown in FIG. 11c, if base ply 1101c and top ply 1103c are both opaque, then removal of portions 1105c and 1105c1 from both plies, respectively, could, for example, enable visual observation of a level of a product within a non-opaque container as aforedescribed. It is to be understood that portions 1105c and 1105c1 could also be removed as a single unit by way of any suitable bonding means between the plies to join together portions 1105c and 1105c1.

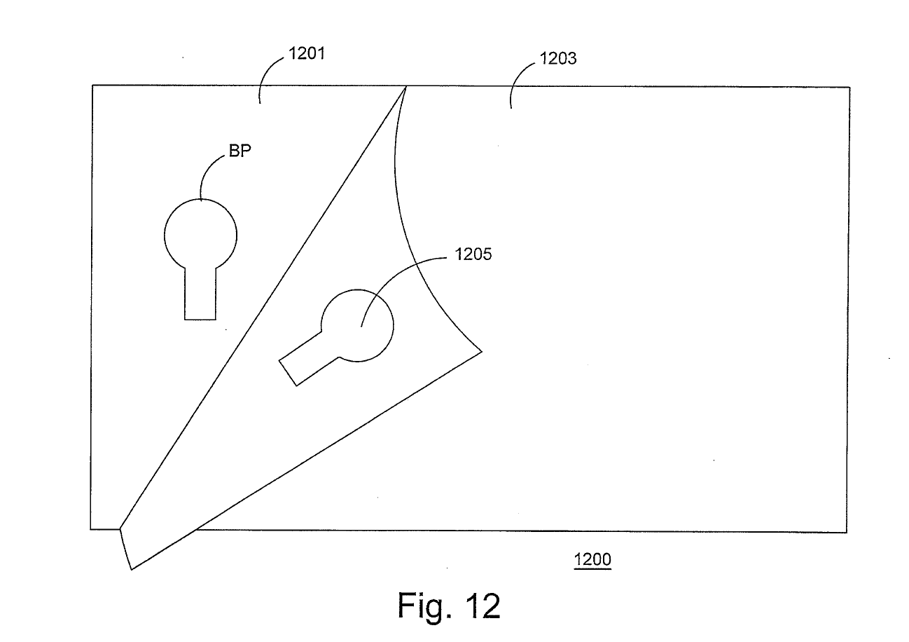

FIG. 12 is a top view illustration of another embodiment of a partially opened label with an active portion 1200. Label 1200 includes a base ply 1201, a top ply 1203, a hinge (not illustrated) comprising an adhesive material between plies 1201 and 1203, and a release-reseal system (not illustrated) comprising corresponding adhesive material and release material between plies 1201 and 1203. In this embodiment, a removable element 1205 may be provided via a portion of base ply 1201 and defined by a break path (BP) in base ply 1201 that is strong enough to remain intact during manufacture and application but weak enough to permit transfer of element 1205 to a back surface of top ply 1203 upon opening label 1200. Such transfer could be facilitated by any suitable bonding means between the plies. Then, a consumer or end-user could subsequently remove the removable element 1205 from the back surface of the top ply in coupon-like fashion. It is to be understood that removable element 1205 could, as desired in a particular embodiment, also remain bonded to the back surface of the top ply.

It is to be appreciated and understood that, although not specifically illustrated, a label with an active portion that incorporates a coupon feature could, additionally or alternatively, provide a removable booklet. For example, in FIG. 9, the active portion could comprise a booklet; and the booklet could also be of a construction that includes one or more material plies in addition to base ply 901 and top ply 903. Further, although not specifically illustrated, a label with an active portion that incorporates a coupon feature could, additionally or alternatively, provide a removable material safety data sheet as aforementioned.

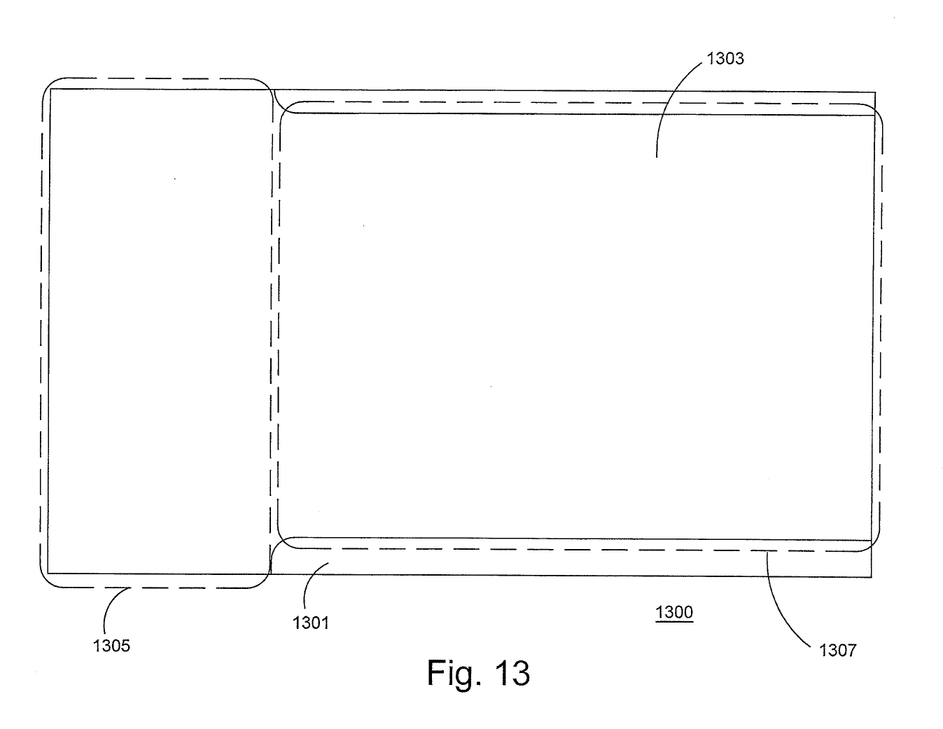

FIG. 13 is a top view illustration of another embodiment of a label with an active portion 1300. Label 1300 includes a base ply 1301, a top ply 1303, a hinge (not illustrated) comprising an adhesive material between plies 1301 and 1303, and a release-reseal system (not illustrated) comprising corresponding adhesive material and release material between plies 1301 and 1303. In this embodiment, top ply 1303 is configured with a portion 1305 that corresponds to dimensions of base ply 1301 and a portion 1307 that is smaller than base ply 1301. It is to be appreciated and understood that when label 1300 is adhered to a container such as an aerosol spray can, subsequently with a cap, portion 1305 could reside under the cap while portion 1307 could be sufficiently free from the cap to thereby advantageously enable opening and closing of the label while the cap remains on the can. It is also to be understood that dimensions of top ply 1303 could be any that define portions which could thus reside under the cap and be sufficiently free from the cap, to enable opening and closing of the label while the cap remains on the can as aforesaid. It is to be further understood that in another embodiment of label 1300, although not specifically illustrated, top ply 1303 could be configured or dimensioned such that its bottom edge (with respect to portion 1307 in FIG. 13) could correspond directly to and be commensurate with a bottom edge of base ply 1301. Thus, in such an embodiment, only a topmost portion of top ply 1303 would be smaller than base ply 1301.

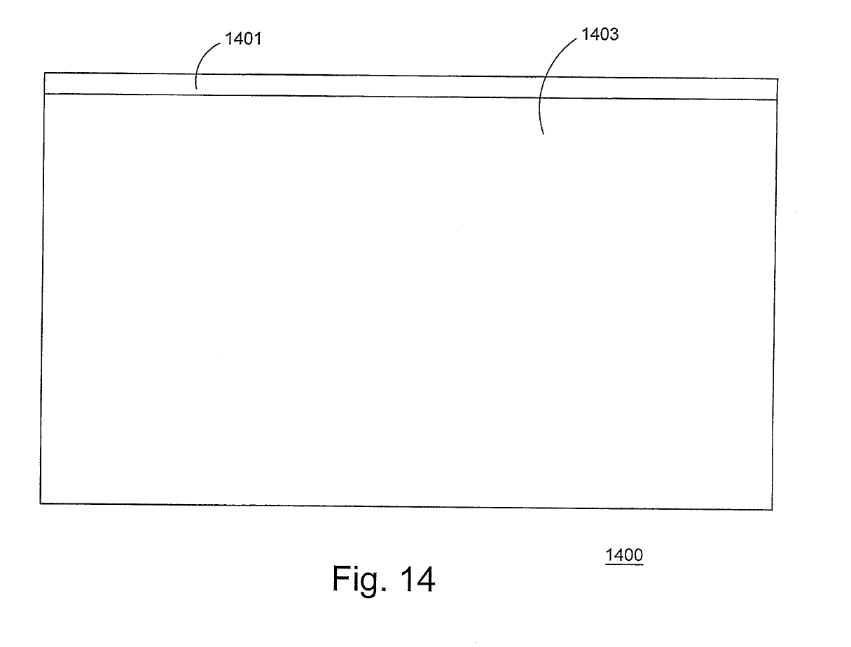

FIG. 14 is a top view illustration of another embodiment of a label with an active portion 1400. Label 1400 includes a base ply 1401, a top ply 1403, a hinge (not illustrated) comprising an adhesive material between plies 1401 and 1403, and a release-reseal system (not illustrated) comprising corresponding adhesive material and release material between plies 1401 and 1403. In this embodiment, top ply 1403 corresponds to dimensions of base ply 1401 except for a topmost margin from which base ply 1401 extends such that top ply 1403 is therefore smaller than base ply 1401. It is to be appreciated and understood that when label 1400 is adhered to a container such as an aerosol spray can, subsequently with a cap, top ply 1403 could be sufficiently free from the cap to thereby advantageously enable opening and closing of the label while the cap remains on the can. It is also to be understood that dimensions of top ply 1403, and thus the aforesaid topmost margin, could be any that provide sufficient freedom from the cap to enable opening and closing of the label while the cap remains on the can as aforesaid.

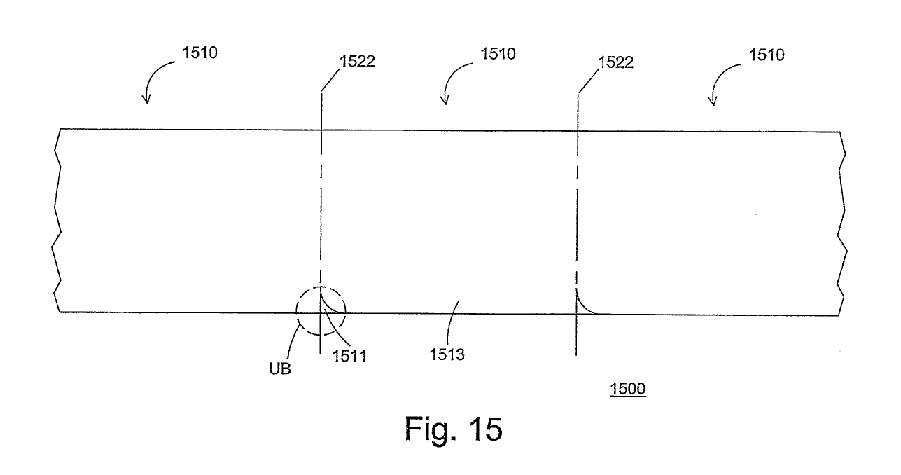

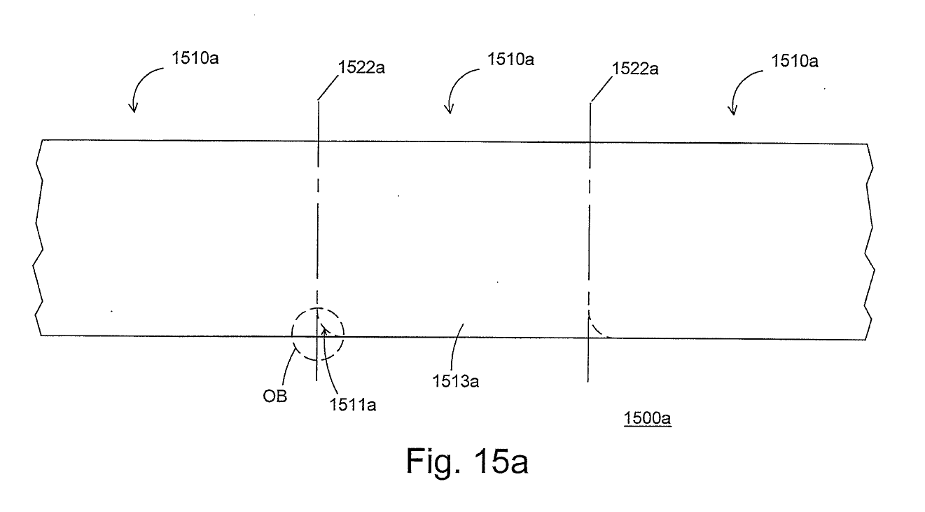

FIG. 15 is an illustration of another example of a portion of a label web 1500 for a label with an active portion 1510. Each label 1510 includes a base ply 1511, a top ply 1513, a hinge (not illustrated) comprising an adhesive material between plies 1511 and 1513, and a release-reseal system (not illustrated) comprising corresponding adhesive material and release material between plies 1511 and 1513. Web 1500 is further defined by cut lines 1522, where the web may be cut by a roll-fed label application machine. Each label 1510 further includes an “underbite” area (UB) where top ply 1513 is dimensioned smaller than base ply 1511. A purpose of underbite area UB is to enable a consumer or end-user to easily open label 1510, by allowing top ply 1513 to be readily grasped and pulled without also grasping and pulling base ply 1511. Although shown in the drawing as a simple curve or arc, it is to be understood that underbite area UB could take any desired form or dimension to permit such selective grasping and pulling of top ply 1513 as aforesaid.

FIG. 15a is an illustration of another example of a portion of a label web 1500a for a label with an active portion 1510a. Each label 1510a includes a base ply 1511a, a top ply 1513a, a hinge (not illustrated) comprising an adhesive material between plies 1511a and 1513a, and a release-reseal system (not illustrated) comprising corresponding adhesive material and release material between plies 1511a and 1513a. Web 1500a is further defined by cut lines 1522a, where the web may be cut by a roll-fed label application machine. Each label 1510a further includes an “overbite” area (OB) where base ply 1511a is dimensioned smaller (designated by a phantom curve or arc) than top ply 1513a. A purpose of overbite area OB is to enable a consumer or end-user to easily open label 1510a, by allowing top ply 1513a to be readily grasped and pulled without also grasping and pulling base ply 1511a. Although shown in phantom line as a simple curve or arc, it is to be understood that overbite area OB could take any desired form or dimension to permit such selective grasping and pulling of top ply 1513a as aforesaid.

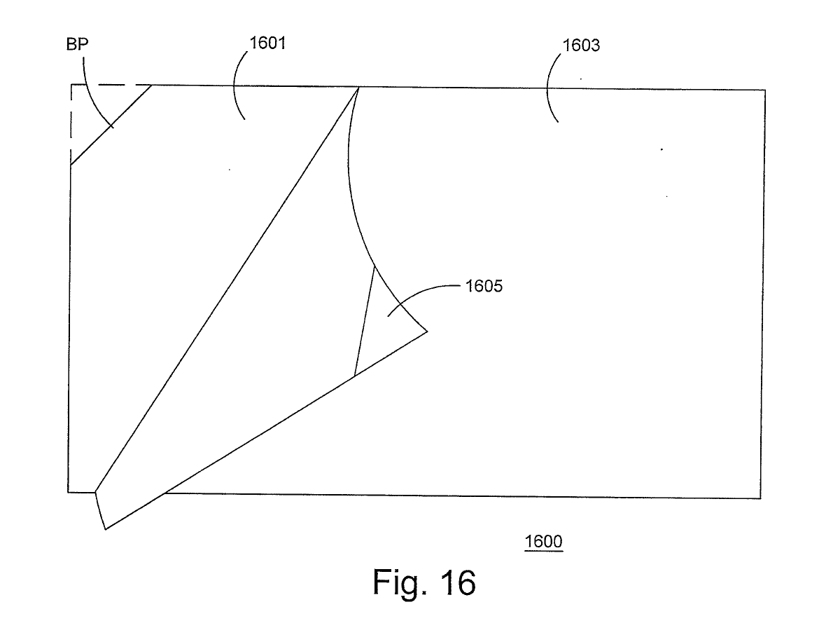

FIG. 16 is a top view illustration of another embodiment of a partially opened label with an active portion 1600. Label 1600 includes a base ply 1601, a top ply 1603, a hinge (not illustrated) comprising an adhesive material between plies 1601 and 1603, and a release-reseal system (not illustrated) comprising corresponding adhesive material and release material between plies 1601 and 1603. In this embodiment, an element 1605 may be provided via a portion of base ply 1601 and defined by a break path (BP) in base ply 1601 that is strong enough to remain intact during manufacture and application but weak enough to permit transfer of element 1605 to a back surface of top ply 1603 upon opening label 1600. Such transfer could be facilitated by any suitable bonding means between the plies. A purpose of element 1605 is to enable a consumer or end-user to easily open label 1600, by allowing top ply 1603 to be readily grasped and pulled without also grasping and pulling base ply 1601. Although the break path BP and, correspondingly, element 1605 are shown as having simple diagonal geometries, it is to be understood that they could take any desired form or dimension to permit such selective grasping and pulling of top ply 1603 as aforesaid.

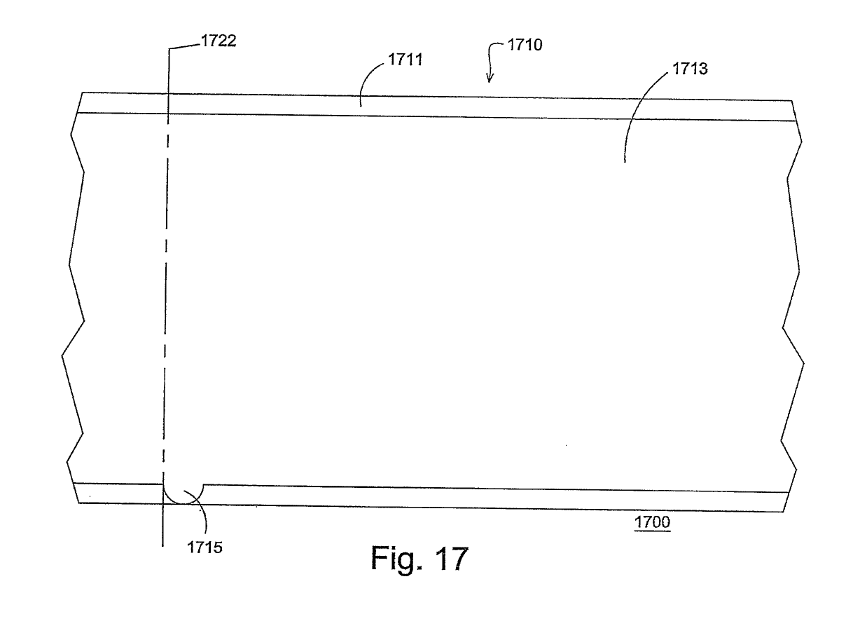

FIG. 17 is an illustration of another example of a portion of a label web 1700 for a label with an active portion 1710. Each label 1710 includes a base ply 1711, a top ply 1713, a hinge (not illustrated) comprising an adhesive material between plies 1711 and 1713, and a release-reseal system (not illustrated) comprising corresponding adhesive material and release material between plies 1711 and 1713. Web 1700 is further defined by cut lines 1722, where the web may be cut by a roll-fed label application machine. Each label 1710 further includes a lift tab 1715 provided by an irregularly shaped portion of top ply 1713 compared to its overall dimensions. A purpose of lift tab 1715 is to enable a consumer or end-user to easily open label 1710, by allowing top ply 1713 to be readily grasped and pulled without also grasping and pulling base ply 1711. Although lift tab 1715 is shown as having a simple semi-circular geometry, it is to be understood that it could take any desired form or dimension to permit such selective grasping and pulling of top ply 1713 as aforesaid. It is to be appreciated that in some embodiments of a label with an active portion, the base plies and top plies could have similar or identical dimensions except for the lift tabs.

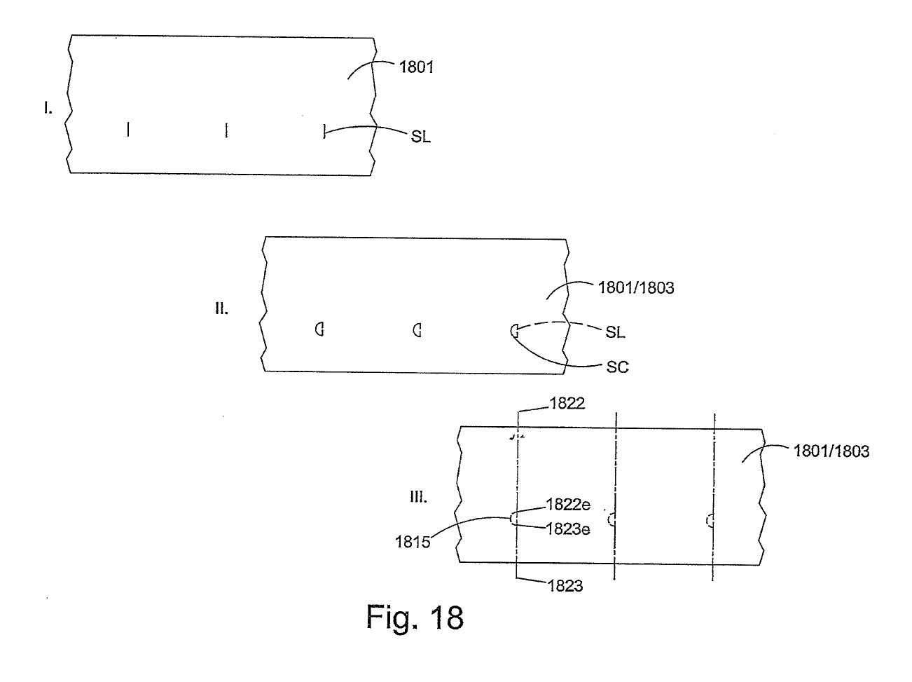

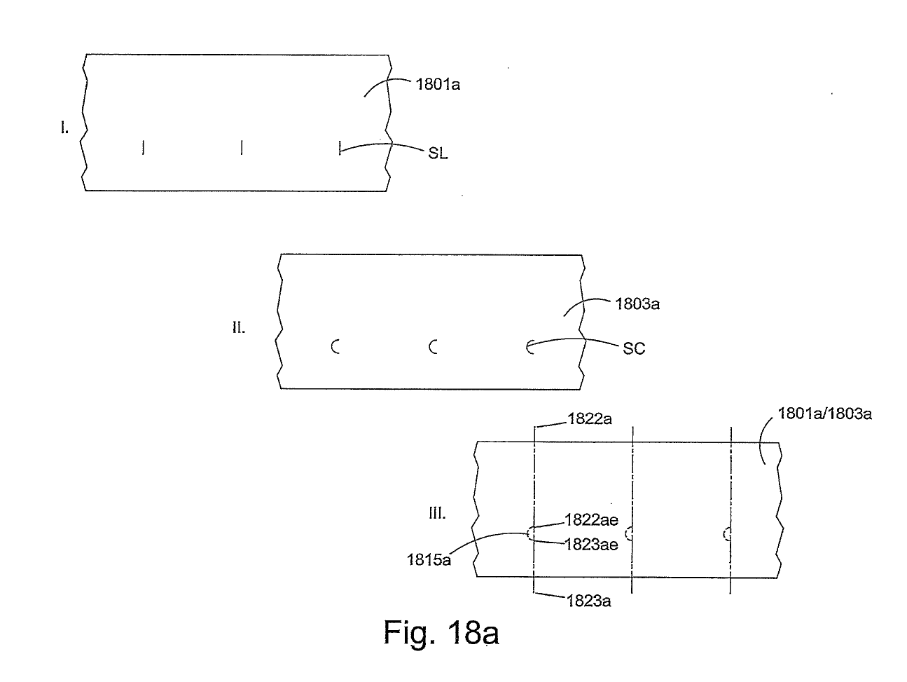

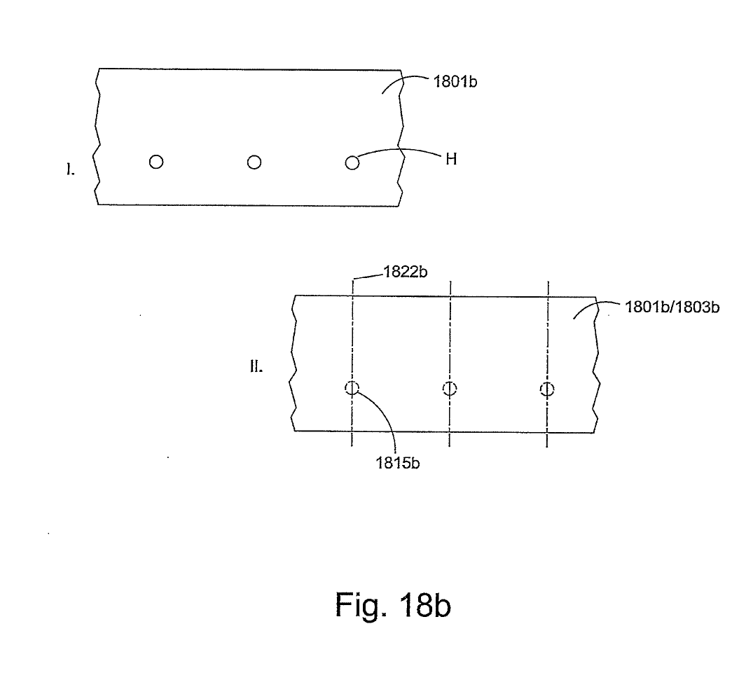

FIG. 18 is a progressive top view illustration of corresponding portions of label webs in an example of construction of a label with an active portion. With reference to FIG. 18 from top to bottom in the drawing, at I., a label web comprising base ply 1801 includes a sequence of slits SL. Next in the drawing, at II., a label web comprising top ply 1803 is married to the label web comprising base ply 1801 (not visible) and a sequence of semi-circular cuts SC are made, in registration with slits SL in base ply 1801, through top ply 1803 and base ply 1801. Slits SL and semi-circular cuts SC could be made in the webs as aforementioned by way of any suitable means or technique such as aforedescribed (e.g., a slit, a cut, a perforation, a score, or a break, by means of, e.g., a steel knife, a heating element, a laser, or a die-cutting process). Finally in the drawing at III., depicting point of application, the combined label webs of base ply 1801 and top ply 1803—with their slits SL and cuts SC—are cut by a roll-fed label application machine at cut lines 1822 and 1823. It is to be understood that in this example, cut lines 1822 and 1823 are separate and terminate at, respectively, end points 1822e and 1823e. Thus it is to be further understood that cut lines 1822 and 1823 are proximate to an area in the combined webs where slits SL are present in base ply 1801 but do not extend therethrough. Thus, the semi-circular cuts SC are thereby not “knocked-out” of top ply 1803. It is to be appreciated and understood, therefore, that a lift tab 1815 (similar to, e.g., lift tab 1715 in FIG. 17 as aforedescribed) is therefore created in such a label with an active portion, when the label is separated from the combined webs and adhered to an object at point of application. Although lift tab 1815 is shown as having a simple semi-circular geometry like lift tab 1715, it is to be understood that lift tab 1815 could take any desired form or dimension. Cut lines 1822 and 1823 could be provided by any suitable techniques in a roll-fed label application machine such as, for example, by employing a segmented or gaped knife or by employing two separate knives separated by a gap, corresponding to a length of each slit SL. Furthermore, each individual label resulting from this process could include a hinge (not illustrated) comprising an adhesive material between plies 1801 and 1803, and a release-reseal system (not illustrated) comprising corresponding adhesive material and release material between plies 1801 and 1803.

FIG. 18a is a progressive top view illustration of corresponding portions of label webs in another example of construction of a label with an active portion. With reference to FIG. 18a from top to bottom in the drawing, at I., a label web comprising base ply 1801a includes a sequence of slits SL. Next in the drawing, at II., a label web comprising top ply 1803a includes a sequence of semi-circular cuts SC made in registration with slits SL in base ply 1801. Slits SL and semi-circular cuts SC could be made in the webs as aforementioned by way of any suitable means or technique such as aforedescribed. Finally in the drawing at III., married label webs comprising base ply 1801a (not visible) and top ply 1803a—with their respective slits SL and cuts SC—are cut by a roll-fed label application machine at cut lines 1822a and 1823a. It is to be understood that in this example, cut lines 1822a and 1823a are separate and terminate at, respectively, end points 1822ae and 1823ae. It is to be further understood that cut lines 1822a and 1823a are proximate to an area in the combined webs where slits SL are present in base ply 1801a but do not extend therethrough and thus the semi-circular cuts SC are thereby not “knocked-out” of top ply 1803a. It is to be appreciated and understood, therefore, that a lift tab 1815a (similar to, e.g., lift tab 1815 in FIG. 18 as aforedescribed) is therefore created in such a label with an active portion, when the label is separated from the combined webs and adhered to an object at point of application.

FIG. 18b is a progressive top view illustration of corresponding portions of label webs in yet another example of construction of a label with an active portion. With reference to FIG. 18b from top to bottom in the drawing, at I., a label web comprising base ply 1801b includes a sequence of holes H. Holes H could be made in the web by way of any suitable means or technique such as aforedescribed. Finally in the drawing at II., married label webs comprising base ply 1801b (not visible) with its holes H and top ply 1803b are cut by a roll-fed label application machine at cut lines 1822b. It is to be understood that cut lines 1822b preferably intersect an area in the combined webs where holes H are present in base ply 1801b. It is to be appreciated and understood, therefore, that a lift void or indent 1815b is therefore created in such a label with an active portion, when the label is separated from the combined webs and adhered to an object at point of application.

Although lift tabs 1815 and 1815a, and lift indent 1815b, are shown as having simple semi-circular geometries like lift tab 1715, it is to be understood that the lift tabs and lift indents could take any desired form or dimension. Also, the aforementioned gaped cut lines for creation of lift tabs 1815 and 1815a could be provided by any suitable techniques in a roll-fed label application machine such as, for example, by employing a segmented or gaped knife or by employing two separate knives separated by a gap, corresponding to a width of slits SL. Furthermore, each individual label resulting from these various processes could include a hinge (not illustrated) comprising an adhesive material between the base and top plies, and a release-reseal system (not illustrated) comprising corresponding adhesive material and release material between the plies.

Although not illustrated herein, it is to be appreciated and understood that a label with an active portion could also include a so-called “microburst” feature whereby manipulation of the label's active portion by a consumer or end-user would cause activation of microburst particles for, e.g., release of a fragrance encapsulated within the microburst particles. In such a label, the active portion could, for example, enclose or contain microbust particles between its plies. The particles could then be burst or activated upon separation of the plies by the consumer or end-user. Also, although again not illustrated, it is to be appreciated and understood that a label with an active portion could in addition to, or as an alternative to, the aforedescribed microburst feature, include a so-called “scratch and sniff” feature. In such an embodiment, the scratch and sniff feature could be provided by way of, for example, a scratch and sniff coating on any desired surface of one or more of the label's plies.

It is to be appreciated and understood that in a particular embodiment of a label with an active portion, any areas or regions of the label defined by that label's height H, length L, or any combinations of its parameters, could serve as the active portion. In a particular embodiment of a label with an active portion, it is also to be appreciated and understood that any portion of any ply material could be made capable of intentional removal by a consumer or end-user by way of, e.g., strategic provision of a break path or break paths in the label. Additionally, it is to be appreciated and understood that in a particular embodiment of a label with an active portion, the label could have a plurality of separate active portions such as, e.g., a plurality of “windows” for, e.g., accommodation and presentation of multi-lingual information.

Regarding constructions of various embodiments of a label with an active portion, the base plies and top plies could preferably be any commercially available web-like materials that are capable of use in an in-line printing and converting process. Such materials could be, for example, polypropylene as is commercially available from AET Films of Terre Haute, Ind., in the U.S. As used herein, the term “web-like materials” is intended to include any suitable label materials, including paper, film, polypropylene, polyethylene, polyester, polyvinylchloride, polystyrene, foil, and ethylene vinyl acetate. The plies selectively could, individually or collectively, comprise so-called “shrink promoting” materials to conform to several or irregular curvatures of objects to which they are applied. Such materials include, but are not limited to, those that exhibit desired stretch and shrinkage characteristics such as are commercially available and known to those skilled in the art. Also, adhesive materials and release materials that may be utilized in constructions of various embodiments of a label with an active portion could preferably be chosen from water-based, solvent-based, UV/EB, cold seal, heat seal, cohesive, and hot melt coatings as are commercially available. The adhesive materials, which may be either (i) tacky in a final state (e.g., pressure-sensitive) or (ii) non-tacky in a final state, are preferably chosen to provide bonding between the base plies and the top plies in the labels described herein, while the release coatings are preferably chosen with respect to, and in combination with, the adhesive materials to provide ease of opening and resealability of the labels. Furthermore, it is to be understood that an adhesive material utilized for provision of a hinge in a particular label with an active portion could be, as may be desired in certain circumstances, different than an adhesive material utilized for provision of a release-reseal system in the same label.

Generally, it is to be appreciated and understood that several of those embodiments of a label with an active portion described herein could have particularly utility in labeling objects or containers that have a regular shape, which may be cylindrical, or another shape, which is of constant circumference from top to bottom. Other objects or containers, however, may have coved or rounded top and bottom shoulder-type tapers which, it is to be understood, also could be accommodated by a particular embodiment of a label with an active portion.

While this disclosure has been particularly shown and described with reference to accompanying figures, it will be understood, however, that modifications are possible. It should be appreciated that various components described herein may be substituted for other suitable components for achieving desired results, or that various accessories may be added thereto. Thus, for example, any aforementioned coatings, materials, and graphics could be selectively provided in any suitable combination or order, on or with any ply material or materials, in construction of a label with an active portion as may be desired in a particular embodiment thereof.

Also, the depictions of various containers in the figures are only exemplary and not meant to be limiting.

It is to be understood that any suitable alternatives may be employed to provide a label with an active portion.

Lastly, the choice of compositions, sizes, and strengths of various components described herein are to be selected depending upon intended use.

Accordingly, these and other various changes or modifications in form and detail may be made to a label with an active portion, without departing from the true spirit and scope thereof.

What is claimed is:

1. A roll-fed label web for a label with an active portion, said roll-fed label web comprising:
a base ply;
at least one top ply;
a plurality of separate, repeating cut zones; and
a plurality of separate, repeating bond areas between
said base ply and said at least one top ply, said bond areas being set back from said cut zones.

2. The roll-fed label web of claim 1, wherein said separate, repeating bond areas alternatively define a hinge and a release-reseal system.

3. The roll-fed label web of claim 2, from which an individual label with an active portion is produced when said roll-fed label web is cut at said cut zones by a label application machine, said label with an active portion having adhesive-free opposing ends.

4. A roll-fed label web for a label with an active portion, said roll-fed label web comprising:
a base ply;
at least one top ply;
a plurality of separate, repeating cut zones; and
a continuous bond area between said base ply and said
at least one top ply, said continuous bond area being defined by flood coats of an adhesive material and a release material.

5. The roll-fed label web of claim 4, from which an individual label with an active portion is produced when said roll-fed label web is cut at said cut zones by a label application machine, said label with an active portion effectively having a hinge portion when said label is adhered to an object at point of application.

6. A roll-fed label web for a label with an active portion, said roll-fed label web comprising:
a base ply;
at least one top ply;
a plurality of separate, repeating cut zones; and
at least one bond area between said base ply and said
at least one top ply, said at least one bond area being defined by adhesive materials selected from a group consisting of (a) a flood coat of adhesive material in at least one selected area and (b) a continuous flood coat of adhesive material.

7. The roll-fed label web of claim 6, from which an individual label with an active portion is produced when said roll-fed label web is cut at said cut zones by a label application machine, wherein said adhesive material is relatively less aggressive as compared to other adhesive materials.

8. The roll-fed label web of claim 6, from which an individual label with an active portion is produced when said roll-fed label web is cut at said cut zones by a label application machine, wherein at least one of said base ply and said at least one top ply inherently has a release property.

9. A roll-fed label web for a label with an active portion, said roll-fed label web comprising:
a base ply;
at least one top ply; and
a plurality of separate, repeating cut zones.

10. The roll-fed label web of claim 9, from which an individual label with an active portion is produced when said roll-fed label web is cut at said cut zones by a label application machine, wherein at least one of said base ply and said at least one top ply is a cling-like material.

11. A roll-fed label web for a label with an active portion, said roll-fed label web comprising:
a base ply;
at least one top ply;
a plurality of separate, repeating cut zones;
at least one bond area between said base ply and said
at least one top ply, said at least one bond area being defined by an adhesive material and a release material; and
a release material on a back surface of said base ply.

12. The roll-fed label web of claim 11, from which an individual label with an active portion is produced when said roll-fed label web is cut at said cut zones by a label application machine, said label with an active portion effectively having a hinge portion when said label is adhered to an object at point of application.

13. A roll-fed label web for a label with an active portion, said roll-fed label web comprising:
a base ply;
at least one top ply;
a plurality of separate, repeating cut zones; and
physical bonding between said base ply and said at least one top ply.

14. The roll-fed label web of claim 13, (i) wherein said physical bonding is achieved by a technique selected from a group consisting of mechanical interlocking, thermal interlocking, and sonic welding, and (ii) from which an individual label with an active portion is produced when said roll-fed label web is cut at said cut zones by a label application machine.

15. A roll-fed label web for a label with an active portion, said roll-fed label web comprising:
a base ply;
at least one top ply;
a plurality of separate, repeating cut zones; and
a pattern of adhesive material on a selected one of (i) a front surface of said base ply and (ii) a back surface of said at least one top ply.

16. The roll-fed label web of claim 15, (i) wherein said pattern of adhesive material is selected from a group consisting of (a) a pattern of adhesive material in at least one selected area and (b) a continuous pattern, and (ii) from which an individual label with an active portion is produced when said roll-fed label web is cut at said cut zones by a label application machine.

17. The roll-fed label web of claim 16, wherein said pattern of adhesive material additionally has an adhesive-free area thereby creating a window area.

18. A roll-fed label web for a label with an active portion, said roll-fed label web comprising:
a base ply;
at least one top ply;
a plurality of separate, repeating cut zones; and
a release material on a selected one of (i) a back surface of said at least one top ply and (ii) a front surface of said base ply.

19. The roll-fed label web of claim 18, (i) wherein said release material is selected from a group consisting of (a) a continuous flood coat of release material and (b) a flood coat of release material in at least one selected area, and (ii) from which an individual label with an active portion is produced when said roll-fed label web is cut at said cut zones by a label application machine.

20. A roll-fed label web for a label with an active portion, said roll-fed label web comprising:
a base ply;
at least one top ply;
a plurality of separate, repeating cut zones; and
a plurality of separate, repeating bond areas between
said base ply and said at least one top ply, said bond areas alternatively defining a hinge and a release-reseal system,
wherein an individual label with an active portion is
produced when said roll-fed label web is cut at said cut zones by a label application machine, said active portion being (i) defined by an entire height of said label and (ii) capable of opening in any desired direction.

21. A roll-fed label web for a label with an active portion, said roll-fed label web comprising:
a base ply;
at least one top ply;
a plurality of separate, repeating cut zones; and
a plurality of separate, repeating bond areas between
said base ply and said at least one top ply, said bond areas alternatively defining a hinge and a release-reseal system,
wherein an individual label with an active portion is
produced when said roll-fed label web is cut at said cut zones by a label application machine, said active portion being (i) defined by at least one break path in said at least one top ply and (ii) capable of opening in any desired direction.

22. The individual label of claim 21, with an accessory that is removably secured within said active portion.

23. A roll-fed label web for a label with an active portion, said roll-fed label web comprising:
a base ply;
at least one top ply;
a plurality of separate, repeating cut zones; and
a plurality of separate, repeating bond areas between
said base ply and said at least one top ply, said bond areas alternatively defining a hinge and a release-reseal system,
wherein an individual label with an active portion is
produced when said roll-fed label web is cut at said cut zones by a label application machine, said active portion including at least one portion of said at least one top ply that may be removed to thereby create a window.

24. The roll-fed label web for a label with an active portion of claim 23, wherein said base ply comprises a non-opaque material.

25. A roll-fed label web for a label with an active portion, said roll-fed label web comprising:
a base ply;
at least one top ply;
a plurality of separate, repeating cut zones; and
a plurality of separate, repeating bond areas between
said base ply and said at least one top ply, said bond areas alternatively defining a hinge and a release-reseal system,
wherein an individual label with an active portion is
produced when said roll-fed label web is cut at said cut zones by a label application machine, said active portion including at least one portion of both of said base ply and at least one top ply that may be removed, respectively.

26. The roll-fed label web for a label with an active portion of claim 25, wherein said base ply and said at least one top ply both comprise opaque materials.

27. The roll-fed label web for a label with an active portion of claim 25, wherein said active portion, including at least one portion of both of said base ply and at least one top ply, may be removed as a single unit by way of a bonding means that joins together said at least one portion of both of said base ply and at least one top ply.

28. A roll-fed label web for a label with an active portion, said roll-fed label web comprising:
a base ply;
at least one top ply;
a plurality of separate, repeating cut zones; and
a plurality of separate, repeating bond areas between
said base ply and said at least one top ply, said bond areas alternatively defining a hinge and a release-reseal system,
wherein an individual label with an active portion is
produced when said roll-fed label web is cut at said cut zones by a label application machine, said active portion including at least one break path in at least one portion of said base ply that in turn includes at least one portion of said base ply that may be transferred to a back surface of said at least one top ply by way of a bonding means that correspondingly joins together said at least one portion of said base ply with said back surface of said at least one top ply, upon opening said label.

29. The roll-fed label web for a label with an active portion of claim 28, wherein said at least one portion of said base ply that may be transferred to a back surface of said at least one top ply may be removed from said back surface of said at least one top ply in coupon-like fashion.

30. The roll-fed label web for a label with an active portion of claim 28, wherein said portion that is transferred to a back surface of said at least one top ply enables said at least one top ply to be easily grasped to facilitate opening of said individual label.

31. A roll-fed label web for a label with an active portion, said roll-fed label web comprising:
a base ply;
at least one top ply having (i) at least one portion having dimensions that are substantially equivalent to said base ply and (ii) at least one portion having dimensions that are smaller than said base ply;
a plurality of separate, repeating cut zones; and
a plurality of separate, repeating bond areas between said base ply and said at least one top ply, said bond areas alternatively defining a hinge and a release-reseal system,
wherein an individual label with an active portion is produced when said roll-fed label web is cut at said cut zones by a label application machine.

32. The roll-fed label web for a label with an active portion of claim 31, wherein said at least one portion of said at least one top ply having dimensions that are smaller than said base ply defines an underbite area to enable easy opening of said individual label.

33. A roll-fed label web for a label with an active portion, said roll-fed label web comprising:
at least one top ply;
a base ply having (i) at least one portion having
dimensions that are substantially equivalent to said at least one top ply and (ii) at least one portion having dimensions that are smaller than said at least one top ply;
a plurality of separate, repeating cut zones; and
a plurality of separate, repeating bond areas between
said base ply and said at least one top ply, said bond areas alternatively defining a hinge and a release-reseal system,
wherein an individual label with an active portion is
produced when said roll-fed label web is cut at said cut zones by a label application machine.

34. The roll-fed label web for a label with an active portion of claim 33, wherein said at least one portion of said base ply having dimensions that are smaller than said at least one top ply defines an overbite area to enable easy opening of said individual label.

35. A roll-fed label web for a label with an active portion, said roll-fed label web comprising:
a base ply;
at least one top ply having (i) at least one portion having dimensions that are smaller than said base ply and (ii) at least one portion having dimensions defining a lift tab;
a plurality of separate, repeating cut zones; and
a plurality of separate, repeating bond areas between said base ply and said at least one top ply, said bond areas alternatively defining a hinge and a release-reseal system,
wherein an individual label with an active portion is produced when said roll-fed label web is cut at said cut zones by a label application machine.

36. The roll-fed label web for a label with an active portion of claim 35, wherein said at least one portion of said at least one top ply having dimensions defining a lift tab enables easy opening of said individual label.

37. A roll-fed label web for a label with an active portion, said roll-fed label web comprising:
a base ply having a plurality of separate, repeating slits and cuts therethrough;
at least one top ply having a plurality of separate, repeating cuts therethrough, in registration with said slits and said cuts of said base ply;
a plurality of separate, repeating cut lines proximate to each said registration of said slits and said cuts; and
a plurality of separate, repeating bond areas between said base ply and said at least one top ply, said bond areas alternatively defining a hinge and a release-reseal system,
wherein an individual label with an active portion is produced when said roll-fed label web is cut at said cut lines by a label application machine.

38. The roll-fed label web for a label with an active portion of claim 37, wherein said slits and said cuts together define lift tabs to enable easy opening of individual labels.

39. A roll-fed label web for a label with an active portion, said roll-fed label web comprising:
a base ply having a plurality of separate, repeating slits therethrough;
at least one top ply having a plurality of separate, repeating cuts therethrough, in registration with said slits of said base ply;
a plurality of separate, repeating cut lines proximate to each said registration of said slits and said cuts; and
a plurality of separate, repeating bond areas between said base ply and said at least one top ply, said bond areas alternatively defining a hinge and a release-reseal system,
wherein an individual label with an active portion is produced when said roll-fed label web is cut at said cut lines by a label application machine.

40. The roll-fed label web for a label with an active portion of claim 39, wherein said slits and said cuts together define lift tabs to enable easy opening of individual labels.

41. A roll-fed label web for a label with an active portion, said roll-fed label web comprising:
a base ply having a plurality of separate, repeating holes therethrough;
at least one top ply;
a plurality of separate, repeating cut lines proximate to each of said plurality of separate, repeating holes in said base ply; and
a plurality of separate, repeating bond areas between said base ply and said at least one top ply, said bond areas alternatively defining a hinge and a release-reseal system,
wherein an individual label with an active portion is produced when said roll-fed label web is cut at said cut lines by a label application machine.

42. The roll-fed label web for a label with an active portion of claim 41, wherein said holes define lift voids to enable easy opening of individual labels.

43. The roll-fed label web of claim 1, including a microburst feature.

44. The roll-fed label web of claim 1, including a scratch-and-sniff feature.
